(19) United States
(12) Patent Application Publication
(10) Pub. No.: US 2025/0292704 A1
(43) Pub. Date: Sep. 18, 2025

(54) DISTAL AIRWAY AND ALVEOLI MODEL

(71) Applicant: Philip Morris Products S.A., Neuchatel (CH)

(72) Inventors: Arkadiusz KUCZAJ, Neuchâtel (CH); Francesco LUCCI, Neuchâtel (CH); Antonin Michael SANDOZ, Neuchâtel (CH); Sandro STEINER, Neuchâtel (CH)

(73) Assignee: Philip Morris Products S.A., Neuchatel (CH)

(21) Appl. No.: 18/861,403

(22) PCT Filed: Jul. 10, 2023
(86) PCT No.: PCT/EP2023/069050

§ 371 Date: Oct. 29, 2024

(30) Foreign Application Priority Data
Jul. 15, 2022 (EP) 22185246.0

(51) Int. Cl. G09B 23/30; G09B 23/34

(52) U.S. Cl. CPC G09B 23/303; G09B 23/34

(57) ABSTRACT

A respiratory simulator is provided, including a rigid porous foam, the rigid porous foam including an interconnected open-celled network of: (i) macropores, and (ii) micropores and/or nanopores. A method for determining an effect of a test atmosphere on a simulated distal airway and alveoli of a respiratory tract is also provided. A rigid porous foam for a model of a distal airway and alveoli of a respiratory tract including an interconnected open-celled network is also provided.

### FIELD OF THE INVENTION

The present invention discloses a distal airway and alveoli model that can be used for simulating terminal, transitional and respiratory bronchioles, the alveolar ducts and the alveolar spaces of a respiratory tract. In particular, the present invention can be used to simulate the interaction between inhalable agents and the said regions of a respiratory tract.

### BACKGROUND OF THE INVENTION

Inhalable agents—such as smoke, fumes, aerosolized dust, gases, pollen, bacteria, or aerosols generated by medical inhalers—may have neutral, adverse or beneficial effects on a respiratory tract. The nature and the amplitude of the observable effects depend on the delivered dose of the inhaled agent, which is the amount of the test agent or individual constituents thereof that deposit on or diffuse into the epithelia of the respiratory tract. The delivered dose is influenced by the properties of the inhaled test agent and by the properties of the respiratory tract. Relevant properties of the test agent include its concentration, its composition and the physical and chemical characteristics of each of its constituents, for instance particle sizes, particle densities, vapor pressures, diffusivities or water solubilities. Relevant properties of the respiratory tract include its geometry and surface properties, which gradually change from the nasal and upper thoracic airways down to the respiratory zones in the distal lung. The dose delivered from a given inhaled agent to a given region of the respiratory tract therefore varies along the respiratory tract. Moreover, as the fraction of an inhaled agent that deposited in the upper airways is not available for deposition in the distal airways anymore, the composition of the inhaled agent changes. Accordingly, different regions of the respiratory tract are exposed to different test agents, which further increases the non-uniformity of the delivered dose across the respiratory tract.

The ability to simulate these deposition patterns outside of a living organism would be of great value in the field of in vitro inhalation sciences. It would allow conducting physiologically relevant in vitro exposures of cell cultures of respiratory tract epithelia—such as human respiratory tract epithelia. Realistic exposure conditions and physiologically relevant dose delivery would increase the in vitro and in vivo translatability of the biological responses to such exposures as compared to currently applied methodologies. During the development of inhalable drugs, for instance, this would reduce the need for expensive, time consuming and ethically debatable animal trials and simultaneously decrease the risk of drug candidate failure during clinical studies.

There are currently no technologies available that reliably simulate the interaction between an inhaled agent and the complete respiratory tract. Idealised or realistic models of the upper airways down to the first couple of generations of bronchial bifurcation have been described and have been built and used for studying particle deposition during breathing. These models, however, are commonly not designed to hold cell cultures for in vitro exposures, do not capture the dynamics in the distal airways or the alveoli and do not create physiologically relevant conditions in terms of the dynamics of breathing, surface properties and sorptivity of the airway walls and humidification of the inhaled agent.

The diameters of the distal airways and the alveoli are in the submillimeter range, so diffusion of gases and small particles present in the inhaled air to the epithelia is fast and efficient. In addition, the total cross-sectional area of the airways increases towards the more distal regions and ultimately reaches approximately 1 m². This design results in a decrease of the flow velocity of the inhaled air towards the more distal regions of the respiratory tract from one to ten meters per second in the upper airways to less than 1 cm per second in proximity to the respiratory zones. The supply of gases (and particles) to the alveoli themselves is entirely driven by diffusion, convectional mass transport does not reach into the alveoli. This has a profound effect on the mass transport from the inhaled air to the respiratory epithelia and the bloodstream. Specifically, the flow velocities in the respiratory zones are optimized to meet the physiological requirements of balancing the convectional transport of inhaled air to and from the alveolar spaces with the diffusional transport of oxygen from the alveolar lumen to and across the alveolar walls in order to optimise blood oxygenation. The distal airways and the alveoli are, due to their structural complexity, difficult to model.

Devices for conducting in vitro exposure of cell cultures representative of distal airways and the alveoli have been described in Tenenbaum-Katan et al. (2018) Biomicrofluidics 12(4), Stucki et al. (2018) Scientific reports 8, 1-3 and Müller et al. (2001) Insciences J. 1, 30-64, but they commonly fail to reproduce the physical conditions and/or the deposition patterns. This is, on one hand, because the geometry of the devices and/or the predominant mechanism governing the deposition of test materials in these devices are not correctly aligned with anatomy. On the other hand, these devices may not be coupled with models of the upper airways and therefore are incapable of shaping the physicochemical properties of the test agent in the way the respiratory tract would, that is, they deliver test agents that are not relevant for the distal airways. Furthermore, the distal airways and the respiratory zones of the respiratory tract are characterised by a large total surface area (for example, in the range of 60-140 m²) which can be entirely covered by an aqueous solution or liquid lining. The respiratory epithelia separate the inhaled volume of air from the blood circulation supplied from the right cardiac ventricle through the pulmonary arteries. The thickness of this blood-gas barrier in the respiratory zones is in the micrometer range and below. The full cardiac output of blood, in the range of, for example, 4-8 liters per minute, reaches the respiratory epithelia via the pulmonary arteries. For any compound present in the inhaled air and able to diffuse across the respiratory epithelium, the rapidly exchanged blood acts as a sink which keeps the concentration gradient between the gas and the epithelium at a relatively constant, high level. Taken together, the large surface area, the short diffusion distances, the optimized flow rates and the relatively high and more or less constant concentration gradient result in a very efficient gas exchange between the inhaled air and the blood. This is true for the two gases that are intended to be exchanged by the lung—oxygen and carbon dioxide—but evidently also for any other gas present in the inhaled air. The same accounts for particles and compounds of low vapor pressure, although they do not rely on their continuous removal from the lung tissue by the bloodstream for being delivered at constant rates; once immersed in the liquid layer lining of the epithelia, they will only to a very limited extent enter the gas phase again, that is, equilibrium conditions are not reached at all, or only after very high masses have been transferred to the epithelia.

WO2019016094 describes a simulated respiratory tract, a device which mimics macroscopic anatomical features of the respiratory tract and can simulate human breathing. WO2020/148238 describes a perforated structure which can be plugged into/at the simulated respiratory tract and further refines the anatomical simulation of the respiratory tract by adding models of lobar and segmental bronchi and bronchioles. Both WO2019016094 and WO2020/148238 can be designed to hold cell cultures, sensors or microfluidic or mesofluidic devices and can be used to conduct in vitro exposures of biological test systems to test aerosols or gases and to determine the deposition of test aerosols or gases in vitro, under physiologically relevant conditions.

There is a need in the art for a system that can simulate the mass transport of aerosols and gases within distal airways and alveoli of the respiratory zones of the respiratory tract in vitro. The present invention seeks to address this and other needs.

### SUMMARY OF THE INVENTION

The present disclosure provides a model of the distal airways and the alveoli. The model can be used for simulating, terminal, transitional and respiratory bronchioles, the alveolar ducts and the alveolar spaces of the respiratory tract. The distal airway and alveolar model can be used to simulate the interaction between inhalable agents and the said regions of the respiratory tract. To achieve this, the distal airway and alveolar model utilises a rigid porous foam. The rigid porous foam that is used in the present disclosure is commercially available and known for use in applications including separation techniques and filtration (for example, dedusting, diesel particulate filtration, filtration of liquids), sound and heat insulation, in chemical and thermal process engineering (for example, catalyst supports, porous burners), in medical technology (for example, bone substitution materials) and as carriers for catalysts.

It is understood that rigid porous foams—especially those comprising an interconnected open-celled network of (i) macropores and (ii) micropores and/or nanopores—have not been described for use in a distal airway and alveoli model of the respiratory tract. One reason for this is that their use for this purpose goes against the intuition of the skilled person. This is because flexible structures would be understood to resemble the respiratory tract more closely. However, the present inventors have found that rigid porous foams are preferable over such flexible structures—such as those manufactured from silicone, rubber, gelatin or similar materials—as they do not have the required stability for a bimodal or hierarchical pore size. This could lead to the collapse of the foam. Moreover, reproducible handling and cleaning of flexible structures is difficult to achieve in the laboratory and strategies for mounting cell cultures within such structures have not been identified so far.

The claimed rigid porous foam is an open celled hierarchical network of: (i) macropores; and (ii) micropores and/or nanopores, that represents a model of the distal airways and alveoli in a respiratory tract. One size of pore (the macropores, which can mimic the size of the alveoli) is capable of conducting a gas or an aerosol supplied to the model and the other pore size (micropores and/or nanopores, which can mimic the size of the distal airway) is capable of conducting an aqueous solution, retaining this aqueous solution within the network of micropores and/or nanopores and providing a liquid film on the surface of the macropores.

The provision of an aqueous or liquid film on the surface of the macropores allows the humidification of gas which occurs in the alveoli and captures the property of evaporative mass flow to the gas phase. A liquid film also has the ability to absorb gases meaning that gases can dissolve in the liquid lining. Advantageously, this improved model can be configured to match the anatomical and physiological characteristics of a respiratory tract to the largest extent possible, including: a large and wet surface, mean distances between any location within the test atmosphere and the system walls in the sub-millimeter range, suitable flow velocities and, optimally, active transport of deposited water-soluble materials away from the site of deposition. This simulates the conditions within the distal regions of the respiratory tract, where the diameters of the airways as well as the diameters of the alveolar sacs are in the sub-millimeter range and the surface is covered by a continuous aqueous or liquid layer. In one aspect, there is disclosed a respiratory simulator comprising a rigid porous foam, the rigid porous foam comprising an interconnected open-celled network of: (i) macropores; and (ii) micropores and/or nanopores.

Suitably, the rigid porous foam is: (i) a ceramic or a metallic rigid porous foam; or (ii) a ceramic and a metallic rigid porous foam; preferably, wherein the rigid porous foam is made of alumina or silicon carbide or oxygen bonded silicon carbide or sintered silicon carbide or a combination of two or more thereof.

Suitably, (i) the macropores contain a gas or an aerosol; or (ii) the micropores and/or nanopores contain an aqueous solution or liquid; or (iii) the macropores contain a gas or an aerosol and the micropores and/or nanopores contain an aqueous solution or liquid.

Suitably, the micropores and/or nanopores containing the aqueous solution or liquid form an aqueous or liquid layer covering a portion or all of the surface of the macropores.

Suitably, the rigid porous foam comprises one or more cavities or sockets or indentations or a combination of two or more thereof, preferably, wherein the one or more cavities or sockets or indentations or a combination of two or more thereof contain one or more sensory devices or probes or sampling devices or cell cultures.

Suitably, at least two rigid porous foams each of different pore size distribution or each of different porosity or each of a different material are used in the respiratory simulator.

Suitably, the respiratory simulator comprises a pump and wherein the rigid porous foam is contained or mounted inside the pump, preferably, wherein the pump is a piston pump.

In another aspect, there is disclosed the use of a rigid porous foam for simulating the distal airways and alveoli of a respiratory simulator, the rigid porous foam comprising an interconnected open-celled network of: (i) macropores; and (ii) micropores and/or nanopores.

Suitably, the rigid porous foam is: (i) a ceramic or a metallic rigid porous foam; or (ii) a ceramic and a metallic rigid porous foam; preferably, wherein the rigid porous foam is made of alumina or silicon carbide or oxygen bonded silicon carbide or sintered silicon carbide or a combination of two or more thereof.

In another aspect, there is disclosed a method for determining the effect of a test atmosphere on a simulated distal airway and alveoli of a respiratory tract comprising: (i) providing the respiratory simulator according to the present disclosure; (ii) contacting the respiratory simulator with the test atmosphere; and (iii) determining the effect of the test atmosphere on the simulated distal airway and alveoli of the respiratory tract.

In another aspect, there is disclosed a rigid porous foam for use in a model of a distal airway and alveoli of a respiratory tract comprising an interconnected open-celled network of: (i) macropores, the macropores containing a gas or an aerosol; and (ii) micropores and/or nanopores, the micropores and/or nanopores containing an aqueous solution or liquid, and wherein the micropores and/or nanopores containing the aqueous solution or liquid form an aqueous or liquid layer covering a portion or all of the surface of the macropores.

Suitably, the rigid porous foam is: (i) a ceramic or a metallic rigid porous foam; or (ii) a ceramic and a metallic rigid porous foam; preferably, wherein the rigid porous foam is made of alumina or silicon carbide or oxygen bonded silicon carbide or sintered silicon carbide or a combination of two or more thereof.

Suitably, (i) the macropores contain a gas or an aerosol; or (ii) the micropores and/or nanopores contain an aqueous solution or liquid; or (iii) the macropores contain a gas or an aerosol and the micropores and/or nanopores contain an aqueous solution or liquid.

Suitably, the rigid porous foam comprises one or more cavities or sockets or indentations or a combination of two or more thereof, preferably, wherein the one or more cavities or sockets or indentations or a combination of two or more thereof contain one or more modules for containing or storing a cell culture medium and/or at least one microsensor for monitoring conditions in the chamber or for gas sampling or for gas characterisation.

Suitably, the rigid porous foam is contained or mounted inside a pump, preferably, wherein the pump is a piston pump.

### SOME ADVANTAGES

Advantageously, the present invention provides an improved model of the distal airways and the alveoli, as discussed herein.

Advantageously, the model of the distal airways and the alveoli can improve the accuracy, reliability and in vitro-in vivo translatability of in vitro methods applied in the context of inhalation toxicology, inhalation dosimetry and the development and pre-clinical testing of drugs for inhalation therapy.

Advantageously, the model of the distal airways and the alveoli allows the deposition of inhalable test agents to be determined, how the interaction with the distal airway and alveolar model affects the physiochemical properties of the inhalable test agents and to assess how in vitro biological test systems respond to exposures to inhalable test agents within such a model. To achieve this, the distal airway and alveolar model can be used in a system that can be configured to allow the introduction of one or more modules, for example, sensory devices, probes, cell cultures and/or sampling devices and the like, including all necessary electrical, optical and microfluidic and/or mesofluidic connections.

Advantageously, the model of the distal airways and the alveoli can be configured to match the anatomical and physiological characteristics of a respiratory tract to the largest extent possible: a large and wet surface, mean distances between any location within the test atmosphere and the system walls in the sub-millimeter range, suitable flow velocities and, optimally, active transport of deposited water-soluble materials away from the site of deposition. This reproduces the conditions within the distal regions of the respiratory tract, where the diameters of the airways as well as the diameters of the alveolar sacs are in the sub-millimeter range and the surface is covered by a continuous aqueous or liquid layer.

Advantageously, the model of the distal airways and the alveoli is not limited to the simulation of the human respiratory tract, but can, with appropriate parametrization of the design, be expanded to any kind of respiratory tract of interest.

Advantageously, the model of the distal airways and the alveoli is not only limited to applications in combination with those described in WO2019/016094 and WO2020/148238. A person skilled in the art may design embodiments of the present disclosure that are compatible with any other device that is used to simulate the interaction between inhalable agents and the respiratory tract.

### BRIEF DESCRIPTION OF THE DRAWINGS

Embodiments of the present disclosure are described in more detail with reference to the accompanying Figures, in which:

FIG. 1 is a schematic visualization of the pore structure of a rigid porous foam according to an embodiment of the present disclosure. The microstructure and macrostructure of the porous foam that can be used in the model of the distal airways and the alveoli described herein is shown. The white areas are macropores that can be filled with gas or aerosol; the grey areas show the micropores and/or nanopores that can be filled with aqueous solution or liquid; the black areas show the ceramic or metallic struts of the foam. The radius rₙ of the micropores and/or nanopores can be between about 0.1 μm and about 20 μm or between about 0.25 μm and about 25 μm. The radius rₘ of the macropores can be between about 200 μm and about 2000 μm or between about 0.1 mm and about 0.4 mm, suitably about 0.25 mm.

FIG. 2 shows a simulated respiratory as tract described in WO2019016094.

FIG. 3 shows one embodiment in cross-sectional view. The model of the distal airways and the alveoli contains a cylindrical rigid porous foam and a cylindrical or disc-shaped structure providing bifurcated channels and is mounted inside a piston pump.

FIG. 4 shows another embodiment in cross-sectional view. The model of the distal airways and the alveoli has three individual rigid porous foams which provide more locations at which one or more modules—such as one or more sensory devices, one or more sampling devices or one or more cell cultures and the like or a combination of two or more thereof can be mounted inside a piston pump to allow the fine tuning the properties of the overall model of the distal airways and alveoli by incorporating foams of different pore sizes, different porosities or different materials, for example.

FIG. 5 shows another embodiment in cross-sectional view. Illustrated is a connection between a supply of aqueous solution or liquid to a rigid porous foam or the connection between the drain for aqueous solution or liquid present in micropores and/or nanopores of the rigid porous foam.

FIG. 6 shows another embodiment in cross-sectional view. Illustrated is an alternative connection between a supply of aqueous solution or liquid to a rigid porous foam or the connection between the drain for aqueous solution or liquid present in micropores and/or nanopores of the rigid porous foam.

FIG. 7 is an illustration of a system 10 containing a first pump 40, a second pump 80, and a connecting structure 50 as described in WO2019016094. In one embodiment, the rigid foam of the present disclosure is housed inside the second pump 80 (not shown).

### DETAILED DESCRIPTION

The practice of the present disclosure employs, in certain embodiments, conventional techniques of engineering, microbiology, cell biology and biochemistry. The biological techniques are explained fully in the literature, such as, in Molecular Cloning: A Laboratory Manual, second edition (Sambrook et al., 1989) Cold Spring Harbor Press; Oligonucleotide Synthesis (M J. Gait, ed., 1984); Methods in Molecular Biology, Humana Press; Cell Biology: A Laboratory Notebook (J. E. CelMs, ed., 1998) Academic Press; Animal Cell Culture (R. I. Freshney, ed., 1987); Introduction to Cell and Tissue Culture (J. P. Mather and P. E. Roberts, 1998) Plenum Press; Cell and Tissue Culture: Laboratory Procedures (A. Doyle, IB. Griffiths, and D. G. Newell, eds., 1993-8) J. Wiley and Sons; Methods in Enzymology (Academic Press, Inc.); Current Protocols in Molecular Biology (F. M. Ausubel et al., eds., 1987); PCR: The Polymerase Chain Reaction, (Mullis et al., eds., 1994). Procedures employing commercially available kits and reagents will typically be used according to manufacturer-defined protocols unless otherwise indicated.

The technical terms and expressions used herein are generally to be given the meaning commonly applied to them in the pertinent art. All of the term definitions used herein apply to the complete content of this application.

The term “comprising” does not exclude other elements or steps.

The indefinite article “a” or “an” does not exclude a plurality.

The term “and/or” means, for example, (a) or (b) or both (a) and (b).

The terms “comprising”, “comprises” and “comprised of” as used herein are synonymous with “including”, “includes” or “containing”, “contains”, and are inclusive or open-ended and do not exclude additional, non-recited members, elements or method steps. The term “consisting of” means that additional components are excluded and has the recited elements only and no more.

The term “about” as used herein when referring to a measurable value such as a parameter, an amount, a temporal duration, and the like, is meant to encompass variations of and from the specified value, in particular variations of +/−10% or less, preferably +1-5% or less, more preferably +/−1% or less, and still more preferably +/−0.1% or less of and from the specified value, insofar such variations are appropriate to perform in the disclosure. It is to be understood that the value to which the modifier “about” refers is itself also specifically, and preferably, disclosed.

The present disclosure can be used in a variety of applications for studying the respiratory tract. For example, embodiments find utility in studying the deposition and/or condensation of one or more constituents present in a test atmosphere on internal surfaces of an apparatus. Embodiments also provide for the evaluation of test atmospheres that can be investigated during their passage through the apparatus in order to study changes in aerosol concentration and/or aerosol particle growth and/or aerosol particle shrinkage. The effects of the test atmospheres towards biological test systems present inside the apparatuses can be studied in embodiments of the present disclosure.

The model of the distal airways and alveoli described herein comprises one or a plurality of rigid porous foams which are commercially available. For example, the foams can be purchased from Fraunhofer Institute for Ceramic Technologies and Systems IKTS, Winterbergstr. 28 01277 Dresden, Germany and Ultramet, 12173 Montague Street, Pacoima, CA 91331, USA. The rigid porous foam can be made of ceramic foams or metal foams. They can be manufactured with various pore sizes, various pore size distributions and differing amounts of open and closed porosity. Ceramic foams can be manufactured by several methods that are well described in the art, for instance, by the replica method (Boettge et al. (2013) Journal of Materials Research 28, 2220-2233), by direct foaming of ceramic slurries (Zheng et al. (2021) Journal of Asian Ceramic Societies 9, 24-29), by 3D printing (Minas et al. (2016) Advanced Materials 28, 9993-9999) or by dealloying (Song et al. (2018) Corrosion Science 134, 78-98). In one such method, known as the replica method, components made of open cellular polyurethane foam are impregnated with ceramic slurries. The oversized material is pressed out, so that only the surfaces of the polymer struts are covered with the ceramic material. The wet ceramic films are dried and the foam parts are debindered whereby the polymer foam is burned out. In a last step, the ceramic is sintered according to the specific sintering conditions of the material. As a result, the ceramic foam components have almost similar cellular structures and geometries as compared to the starting polymer foam parts.

Materials that are used in manufacturing ceramic foams include the carbides and nitrides of boron, aluminum, silicon, titanium, and zirconium, cordierite. In one embodiment, the use of a ceramic foam is preferred.

Methods for manufacturing metal foams are described in Tatt et al. ASM Sc. J. (2021), 16 and Mooraj et al. (2020) Scripta Materialia 177, 146-150. Materials that are used in manufacturing metal foams include gold, titanium or iron.

Accordingly, the rigid porous foam can be a ceramic or metallic rigid porous foam or a ceramic and metallic rigid porous foam. In one embodiment, the rigid porous foam is made of alumina or silicon carbide or oxygen bonded silicon carbide or sintered silicon carbide or a combination of two or more thereof, suitably, an alumina ceramic foam.

Properties of the foams—such as the pore size distribution, homogeneity, mechanical stability, surface properties, porosity, flow resistance or capillary activity are well described in the art and can be fine-tuned through the choice of material, the production method, surface treatment and coatings (see, for example, Hammel et al. (2014) Ceramics International 40, 15351-15370 and Costacurta et al. (2007) J. Am. Ceram. Soc. 90, 2172-2177).

In an embodiment of the invention, the rigid porous foam is not made exclusively of carbon. The rigid porous foam according to the present disclosure has a hierarchical pore size in that it comprises: (i) macropores; and (ii) micropores and/or nanopores. The foam is rigid in structure to provide the required stability to the bimodal or hierarchical pore size of the foam.

The rigidity has to be sufficient to prevent the collapse of the macropores during deflation of the foam. Collapse would likely result in the flooding of the macropores as the difference between the capillary activity of the macropores and the micropores and/or nanopores temporarily vanishes. It could also reduce gas permeability. The amount of rigidity can be measured using Young's modulus. As the skilled person will appreciate, the Young's modulus is a mechanical property that measures the tensile stiffness of a solid material. Various methods are available to measure the Young's modulus of elasticity of a material. For example, the Young's modulus of elasticity can be estimated by taking one or more atomic force microscopy (AFM) images of the material and applying the Derjaguin-Muller-Toporov (DMT) mechanical contact model to the withdrawal curves. Alternatively, the Young's modulus can be calculated by measuring the slope of the unloading curve of a load-displacement plot obtained by mechanical compression of the material. The minimum value for the Young's modulus of the rigid porous foam (that is, the value at which significant occlusion of macropores could be expected) is about 20 kPa for a metallic and/or ceramic rigid porous foam.

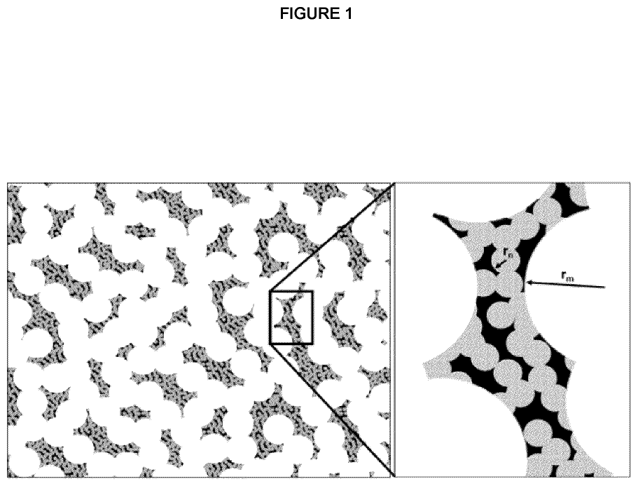

The rigid porous foam is an open celled network of: (i) macropores; and (ii) micropores and/or nanopores. The macropores are capable of conducting a gas or an aerosol (for example, an inhalable test agent) supplied to the distal airway and alveolar model. The micropores and/or nanopores are capable of being filled with an aqueous solution or liquid, for example, water, that can be retained and conducted. The aqueous solution or liquid is retained within the network of micropores and/or nanopores to provide an aqueous or liquid film on the surface of the macropores. The micropores and/or nanopores are present within the ceramic or metallic struts of the rigid porous foam forming the macropores. A schematic visualization of the pore structure of the rigid porous foam is shown in FIG. 1. The micropores and/or nanopores can be filled with an aqueous solution or liquid and the macropores can be filled with a gas or an aerosol. Since the ceramic or metallic walls of the macropores of the rigid porous foam can be covered with open micropores and/or open nanopores that open towards the macropores, the aqueous solution or liquid present in the micropores and/or nanopores forms an aqueous or liquid layer covering all or part of the macropores' surface. Accordingly, both the macropores and the micropores and/or nanopores form an open-celled, interconnected continuous networks of pores in the foam. In this interconnected network, pairs of macropores are connected by a continuous channel formed by the macropores; pairs of micropores and/or nanopores are connected by a continuous channel formed by the micropores and/or the nanopores; and micropores and/or nanopores are connected to macropores by a continuous channel formed by the micropores and/or nanopores and macropores.

The size of the macropores can mimic the size of alveoli and so the radius of the macropores can correspond to the radius of alveoli. The radius of the macropores can be between about 0.1 to about 0.4 mm, or between about 0.1 to about 0.3 mm, or between about 0.2 to about 0.4 mm, or between about 0.2 to about 0.3 mm, or about 0.25 mm. The radius of the macropores can be between about 100 μm and about 2000 μm or between about 200 μm and about 2000 μm.

The radius of the micropores and/or nanopores is typically between about 0.1 μm and about 50 μm, or between about 0.1 μm and about 40 μm, or between about 0.1 μm and about 30 μm, or between about 0.1 μm and about 20 μm, or between about 0.1 μm and about 10 μm, or between about 0.25 μm and about 25 μm.

The density of the pores in the rigid porous foam can be at least about 30 pores per inch, at least about 45 pores per inch, at least about 60 pores per inch or at least about 80 pores per inch. In certain embodiments, the density of the pores in the rigid porous foam is from 40 to 50 pores per inch. In certain embodiments, the density of the pores in the rigid porous foam is about 45 pores per inch.

The total surface area of the rigid porous foam can be at least 70 metres², preferably 100 metres² or more.

Without wishing to be bound by theory, the filling of the micropores and/or nanopores with aqueous solution or liquid but not the macropores is possible due to the capillarity of the foams, which can be described with Equation 1:

$$Δ P = \frac{2 γ cos θ}{r} \qquad Equation 1$$

The pressure difference ΔP across the aqueous liquid surface present in a capillary vessel relative to the air above this surface is a function of the surface tension γ (in Joules meter²) of the aqueous solution or liquid under consideration and its contact angle θ with the material of the capillary vessel. r is the radius (in meters) of the capillary vessel. The ΔP signifies a negative pressure in the aqueous solution or liquid relative to the surrounding air (in the application described here, atmospheric pressure). The contact angles of solid materials with water vary widely, and for capillary rise to be observed, they should be lower than 90°. Glass for instance has a contact angle of zero, and for many ceramic materials, similar values can be assumed. It follows from Equation 1 that, if in a hierarchical foam, the average diameter of the micropores and/or nanopores is one order of magnitude (ten times) smaller than the average diameter of the macropores, it can be estimated (neglecting effects of surface roughness and irregularities in the foam) that the negative pressure in the aqueous solution or liquid below its surfaces spanning the micropores and/or nanopores is ten times larger than the one below the aqueous solution or liquid surfaces spanning the macropores (the pressure in the surrounding air and the contact angle are identical for both pore types). Therefore, if the aqueous solution or liquid supplied to the rigid porous foam is kept under negative pressure larger in absolute value than the negative pressure arising from the capillarity of the macropores, but smaller than the negative pressure arising from the capillarity of the micropores and/or nanopores, the micropores and/or nanopores, but not the macropores of the rigid porous foam will be filled with aqueous solution or liquid. In one embodiment, the average diameter of the micropores and/or nanopores is about ten times smaller than the average diameter of the macropores. In another embodiment, the aqueous solution or liquid supplied to the rigid porous foam is kept under negative pressure larger in absolute value than the negative pressure arising from the capillarity of the macropores, but smaller than the negative pressure arising from the capillarity of the micropores and/or nanopores.

A further aspect of the present disclosure relates to a method of filling the micropores and/or nanopores but not the macropores of a rigid porous foam as described herein with an aqueous solution or liquid, the rigid porous foam comprising an interconnected open-celled network of: (i) macropores; and (ii) micropores and/or nanopores, comprising: (i) supplying an aqueous solution or liquid to the rigid porous foam under negative pressure which in absolute value is larger than a negative pressure arising from a capillarity of the macropores, but smaller than a negative pressure arising from a capillarity of the micropores and/or nanopores; and (ii) filling the micropores and/or nanopores but not the macropores of the rigid porous foam with the aqueous solution or liquid.

With a sufficiently large difference between the average sizes of the micropores and/or nanopores and the macropores, a drain can be connected to a system (for example, a pump) containing the foam. If the aqueous solution or liquid present in the drain is set to a negative pressure larger than the negative pressure applied to the supply of the aqueous solution or liquid, but smaller than the negative pressure induced by the capillarity of the micropores and/or nanopores, a flux of aqueous solution or liquid from the supply to the drain can be induced while keeping the micropores and/or nanopores filled with the aqueous solution or liquid. Such a drain may act as a simulated blood-flow and may stabilise the concentration gradient between the gas or the aerosol and the aqueous solution or liquid lining present on the surface of the rigid porous foam to a certain extent.

The capillary action of metal or ceramic rigid porous foam types of 30, 45 and 60 pores per inch are sufficient to maintain water columns of more than 20 cm in height (ΔP of more than 2000 Pascal) and without flooding the macropores or increasing the resistance of the rigid porous foam towards air-flow passing through the microporous network.

If required, the distal airway and alveolar model may be a combination of one or a plurality of rigid porous foams. In certain embodiments, the one or the plurality of rigid porous foams may be combined with one or a plurality of different foams or structures containing a plurality of bifurcating channels. One such structure is described in WO2020/148238 relating to a perforated structure comprising a perforated envelope housing one or more branched channels, wherein each perforation is an open terminal of the one or more branched channels. Foam structures providing a plurality of bifurcating channels are preferably made of a ceramic or metallic material that comprises micropores and/or nanopores (not macropores) and can maintain and/or conduct an aqueous solution or liquid as described herein. The bifurcating channels within the structure preferably recapitulate the anatomy the lung, in terms of channel length, bifurcation pattern, bifurcation angles and channel diameters. Such structures can be produced by the same methodologies as the hierarchical foams described herein. Because of the lower complexity (for example, the absence of a hierarchical structure) of the 3D geometry of such structures, 3D printing of ceramic precursors followed by sintering (Minas et al. supra) or 3D printing of metallic materials (Mooraj et al. supra) is possible.

Optimal pore size distributions for specific applications can be identified using computational and empirical approaches. The rigid porous foams can be of high (macro) porosity and pose the same or a lower resistance to gas or aerosol flows passing through them as any of the sections 1-4 in FIG. 1 described in WO2019016094A1. In particular, the rigid porous foams can pose the same or lower resistance to gas or aerosol flows passing through them as any part of the conducting or extrathoracic airways of the respiratory tract.

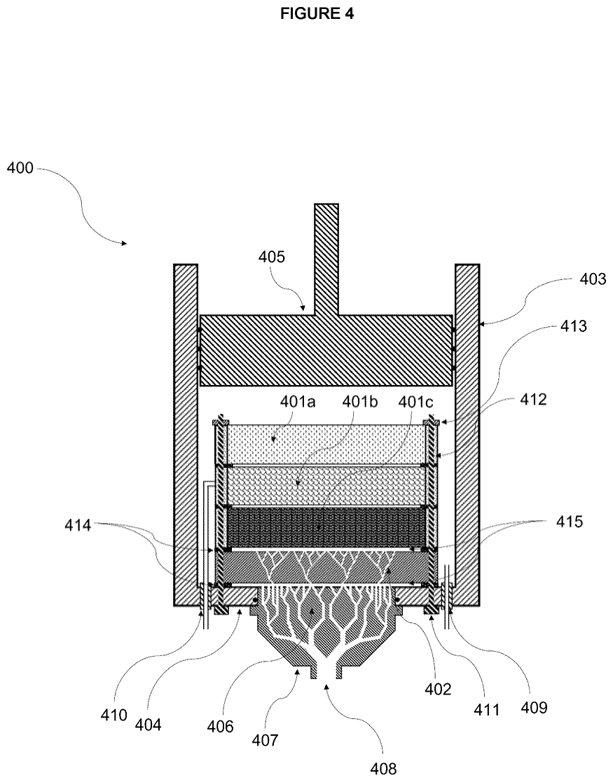

The rigid porous foam can be composed of a plurality of individual units, the individual units providing means for establishing a leak-tight connection between them. In embodiments comprising of two or more individual units of rigid porous foams—such as in the embodiment of FIG. 4—each individual structure may comprise the same or different structure—such as the same or different pore size distributions. For example, it may be desirable to adjust pore size distribution based on specific experimental needs (or example, the simulation of diseased states of the deep lungs). In the embodiment of FIG. 4, three individual rigid porous foams 401a, 401b and 401c, are shown. The presence of two or more individual rigid porous foams allows for introducing more locations at which one or more modules—such as one or more sensory devices, sampling devices or cell cultures and the like can be inserted. The presence of two or more individual rigid porous foams can allow for the fine tuning of the properties of the overall model of the distal airways and the alveoli by incorporating rigid porous foam of, for instance, different pore sizes, porosities or materials.

The rigid porous foam and/or the individual units of the rigid porous foam can be connected to a source or a plurality of sources of an aqueous solution or liquid present in the micropores and/or nanopores.

The rigid porous foam and/or the individual units of the rigid porous foam can be connected to a drain or a plurality of drains towards which the aqueous solution or liquid supplied from the source or plurality of sources can be discarded.

The rigid porous foam can also be used to contain or house one or more modules. If a plurality of modules are used then they can be of the same or a different type. Such modules can be used to monitor operation and/or to conduct experiments and/or to collect samples and/or to house cell cultures and the like. For example, the module(s) can contain or store a cell culture medium containing an optional cell culture, or for monitoring conditions during an experiment or for gas or liquid sampling or for gas characterisation and the like. The module(s) can be a receptacle capable of holding an aqueous solution or liquid—such as cell culture medium.

The module can be a device—such as a probe. Such devices can be used for monitoring internal system conditions or for test atmosphere characterisation or for sampling and the like.

The operation of the module(s) can be controlled by a computer. The module(s) can be a cultivation chamber in which biological test systems, for example, cell cultures or airway epithelial cells and/or alveolar epithelial cells can be placed for test atmosphere exposure. Modules holding quartz crystal microbalances can be used. The module(s) can be placed within the rigid porous foam or in close proximity of the surface of the rigid porous foam, as required. One or more cavities, sockets or indentations can be included within the rigid porous foam into which one or more of the modules can be placed and held or stored.

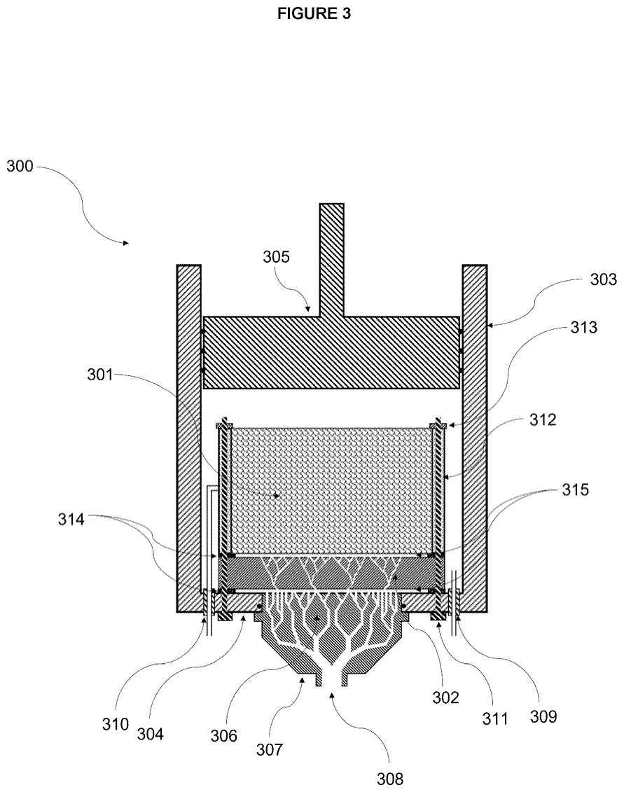

The rigid porous foam can comprise one or more bifurcated channels. The bifurcated channel(s) can bifurcate dichotomously. The bifurcated channel(s) can be present within a structure made of a rigid ceramic or metallic material containing the micropores and/or nanopores. An embodiment containing bifurcated channels can be seen in FIG. 3. In this embodiment, the distal airway and alveolar model contains a cylindrical rigid porous foam 301 and a proximal cylindrical or disc-shaped structure 302 providing bifurcated channels. An additional more proximal airway model 307 such as the one described in WO2020/148238 is also present and connected to the disc-shaped structure 302. The opening of the more proximal airway model 307 bifurcates dichotomously to end in a defined number of smaller, distal openings.

The rigid porous foam may be mounted within a respiratory simulator in such a way that leaves sufficient space at the surface of the rigid porous foam at suitable locations, so one or more of the various modules can be placed and held.

If the model of the distal airways and alveoli comprises a plurality of rigid porous foams or a combination of rigid porous foams and one or more structures providing a plurality of bifurcated channels, they may be connected in a way that leaves sufficient space for placing and holding one or more of the various modules between the individual parts.

To facilitate use, the rigid porous foam can be formed into any desired shape. This may facilitate the intended use of the rigid porous foam—such as in a respiratory simulator. Non-limiting examples of suitable shapes are cylindrically or disc or cuboid. The rigid porous foam shape may be surrounded by a radial wall to contain the shaped foam. The radial wall will typically be composed of a different material to the foam. In one embodiment, the different material does not contain pores. In another embodiment, the different material is a synthetic material—such as an epoxy resin or a metal or a combination thereof.

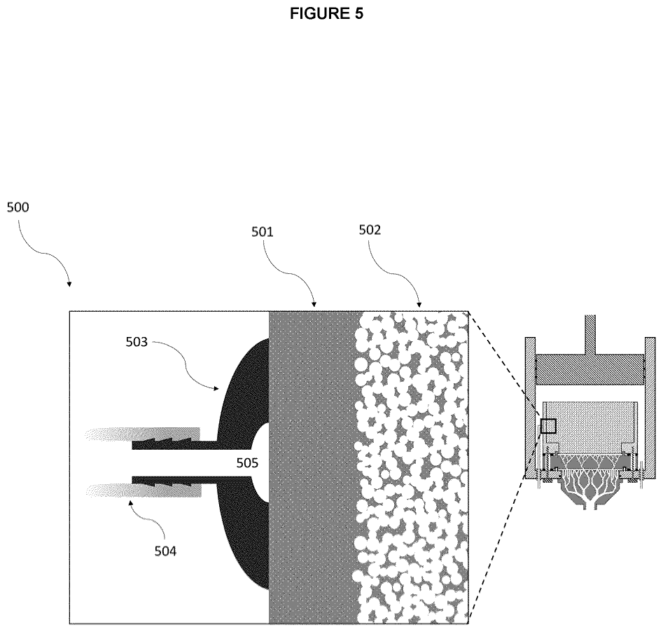

Elements that can be in contact with the rigid porous foam include a bridging structure which can contact the rigid porous foam. This bridging structure can be used for any intended purpose—such as to facilitate the contact of an aqueous solution or liquid circuit with the foam. The circuit can be configured to supply aqueous solution or liquid or drain aqueous solution or liquid from the rigid porous foam. The contact can be achieved by gluing or welding the bridging structure to the foam, or it can be part of the 3D printed design of the foam. An embodiment in which there is a connection between the supply of aqueous solution or liquid to the rigid porous foam or of the connection between the drain for aqueous solution or liquid present in the micropores and/or nanopores of the rigid porous foam can be seen in FIG. 5.

A bridging structure 503 provides connectivity to, for example, a microfluidic or mesofluidic tubing 504 originating at the reservoir of aqueous solution or liquid or another aqueous solution or liquid which can be located outside of a pump. Connection with a microfluidic and/or mesofluidic system establishes constant supply of aqueous solution or liquid, driven by the capillary action of the micropores and/or nanopores of the rigid porous foam, the evaporation of water inside the rigid porous foam and/or the negative pressure applied at the drain.

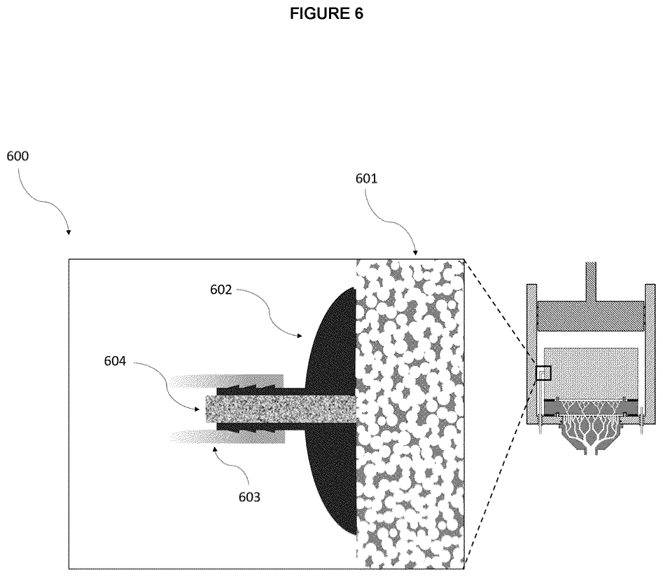

One example of a bridging structure is a microporous and/or nanoporous bridge between the aqueous or liquid circuit and the foam. The microporous and/or nanoporous bridge can be composed of various materials—such as a fibrous or spongy material—such as cellulose acetate fibers—and is preferably flexible and easily deformed so it adapts its shape to the shape of the rigid porous foam at the site of connection and thereby maximizes the contact area with the foam. Such an embodiment can be seen in FIG. 6. A bridging structure 602 (which can, for instance, be glued or welded to the rigid porous foam 601, or which can be part of the 3D printed design of the foam) allows connection of a circuit (supply or drain of aqueous solution or liquid) by means of microfluidic and/or mesofluidic tubing 603. A microporous and/or nanoporous bridge 604 is inserted into the bridging structure 602 to establish contact to the rigid porous foam 601.

One example of a rigid porous foam that can be used in accordance with the present disclosure is an alumina ceramic rigid porous foam having a pore density of 45 pores per inch, an accessible pore volume of 19347 mm³, an isolated pore volume of 5 mm³ and a total pore volume of 19352 mm³. The accessible porosity is 85.65%, the isolated porosity is 0.024% and the total porosity is 85.67%. The average pore diameter is 0.82±0.15 mm. The total volume of the rigid porous foam is 31487 mm³. The rigid porous foam is highly homogenous with negligible isolated porosity. The flow resistance of the rigid porous foam is measured before and after foam wetting. The ΔP across the foam is found to be in the range of 2-10 Pa and physiologically relevant flow velocities, which is in the range of the pressure difference that builds up between the conductive airways and the alveolar spaces in the human lung during normal breathing. Flooding of macropores is limited. Highly efficient water transfer to gas phase (at 10 L/min) of rH from less than 3% to greater than 75% in about 0.6 seconds is achieved indicating excellent air humidification and excellent capillary activity in the foam. The capillary ΔP is greater than 2.5 kPa indicating efficient water supply for humidification. Particle retention in the rigid porous foam is found to meet requirements with respect to particle size and number.

A further aspect of the present disclosure relates to a rigid porous foam for use as a model of a distal airway and alveoli of a respiratory tract comprising an interconnected open-celled network of: (i) macropores, the macropores containing a gas or an aerosol; and (ii) micropores and/or nanopores, the micropores and/or nanopores containing an aqueous solution or liquid, and wherein the micropores and/or nanopores containing the aqueous solution or liquid form an aqueous or liquid layer covering a portion or all of the surface of the macropores. The rigid porous foam generally has the features of the rigid porous foam described previously. As will be appreciated, this rigid porous foam can be integrated or incorporated into a respiratory simulator—such as pump of a respiratory simulator—as described previously. The pump can be a piston pump. There is also disclosed the use of this rigid porous foam for simulating the distal airways and alveoli in a respiratory simulator, as also described previously.

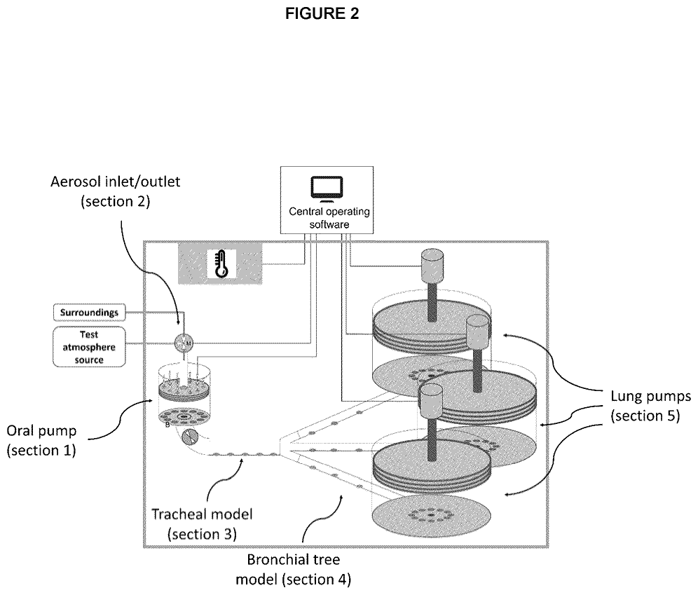

The model of the distal airways and alveoli comprising the rigid porous foam can be conveniently incorporated into a respiratory simulator—such as a component part of a respiratory simulator, which can be a pump or the like. Respiratory simulators are described in the art—such as in WO2019016094, WO2020/148238, WO2022040247 and WO2016118935. Exemplary embodiments in which the distal airway and alveolar model is incorporated inside a pump of a respiratory simulator are shown in FIG. 3, FIG. 4, FIG. 5 and FIG. 6. For example, if the respiratory simulator contains a pump then the model of the distal airways and alveoli can be incorporated to the inside of the pump, which may be a piston pump. Advantageously, this can be achieved without affecting the functionality of the respiratory simulator or the component part thereof. A leak-tight connection can be conveniently established between the model of the distal airways and alveoli and the respiratory simulator. In one embodiment, one or a plurality of the rigid porous foams described herein can be coupled to a model of the lung—such as that described in WO2019/016094A1. According to this embodiment, the rigid porous foam(s) can be placed into a pump which is shown as section 5 in FIG. 2 that connects with the bronchial tree model and the more proximal airway model (section 4 in FIG. 2) that couple the lung models to the tracheal model (section 3 in FIG. 2) to form one continuous structure. The model can provide means for fixing it in the lung pump (section 5 in FIG. 2) and for establishing a leak-tight connection to the bronchial tree model (section 3 in FIG. 2) and between its individual sub-models. The model of the distal airways and alveoli can be connected to a supply of aqueous solution or liquid and/or a drain for the aqueous solution or liquid.

An embodiment of the present disclosure is now described in which the rigid porous foam is mounted inside a piston pump 300. The piston pump 300 can form part of a respiratory simulator. This embodiment is shown in cross-sectional view in FIG. 3. The distal airway and alveolar model comprises a cylindrical rigid porous foam 301 and a cylindrical or disc-shaped structure 302 providing bifurcated channels. The distal airway and alveolar model is inserted into and mounted within the piston pump 300. An example of a respiratory simulator comprising such a pump is described in WO201901609. The piston pump 300 has cylinder walls 303, a base plate 304 and a piston 305. The base plate 304 provides a centrally located opening 306 through which an airway model 307—such as the one described in WO2020/148238A1 which can be used to simulate the effects of the conducting airway tree—is connected. The airway model 307 provides a proximal opening 308 to which models of one or more further proximal airways, for instance a bronchus, can be connected, if required. The opening of the more proximal airway model 307 bifurcates dichotomously to end in a defined number of smaller, distal openings at or in close proximity to the inner plane of the piston pump base plate 304. Optionally, the base plate 304 of the piston pump provides further openings 309, through which one or more sensors, probes, electronic connections or microfluidic or mesofluidic connections can be inserted. A plurality of such openings or one single opening may be present. The openings provide a structure that seals the internal volume of the pump air-tightly from the surroundings. Such structures are well described in the art and may, in the simplest case, comprise a perforated silicon plug through which the connections pass and which seals the perforation in the pump base plate 304. Optionally, the base plate 304 of the piston pump may provide still further openings 310 through which the rigid porous foam 301 and/or the structure 302 can be connected to a supply of aqueous solution or liquid—such as water, and/or to a drain for the aqueous solution or liquid and/or to electronics needed for, for example, heating and/or monitoring temperature. The rigid porous foam 301 is located centrally within the piston pump and mounted, for instance, by screws 311 projecting through the walls 312 of the rigid porous foam 301, the disc-shaped structure 302 and the base plate 304. The screws may, for instance, catch in nuts 313 by means of which the rigid porous foam 301 and the disc-shaped structure 302 are pressed towards the base plate 304. In the depicted embodiment, the radial wall 312 of the rigid porous foam 301 is preferably of a different texture and/or of a different material than the core of the rigid porous foam. For example, the radial wall 312 may be made of the same ceramic or metallic material as the core of the rigid porous foam 301 but does not provide macropores but only micropores and/or nanopores and hence does not conduct aerosols or gases and provides a high capillarity. Alternatively, the radial wall 312 of the rigid porous foam 301 may be made of a synthetic material—such as an epoxy resin or a metal. The radial wall 312 as depicted in FIG. 3 provides the mechanical stability for fixing the rigid porous foam by means of the screws 311, but alternative embodiments may omit the radial wall 312 for the sake of increasing the total cross-sectional area of the flow path through the foam. The contact between the rigid porous foam 301 and the disc-shaped structure 302 and between the disc-shaped structure 302 and the pump base plate 304 may, for instance, be sealed by gaskets or O-rings 314. In this configuration, a suction stroke of the piston 304 forces gases and aerosol through the more proximal airway model 307, and the distal airway and alveolar model comprising the rigid porous foam 301 and the distal airway model 302 into the pump cylinder, a compression stroke of the piston forces gases and aerosols present within the pump through the rigid porous foam 301, the distal airway model 302 and the more proximal airway model 307. Between the pump base plate 304 or the more proximal airway model 306 and the more distal airway model 302, as well as between the more distal airway model 302 and the rigid porous rigid porous foam 301, the gaskets or O-rings 314 introduce gaps 315. The gap between the more proximal airway model 306 and the more distal airway model 302 serves to connect the channels present in the two models, as they are not necessarily located at radially and tangentially the same locations in the two models. The gap between the more distal airway model 302 and the rigid porous foam 301 serves to uniformly connect the foam to the channels present in the airway model, i.e. to avoid the entry of the test agent into the rigid porous foam 301 to be locally limited to the locations of the channels present in the more distal airway model 302. In addition, the gaps 315 between the pump base plate 304 or the more proximal airway model 306 and the more distal airway model 302, as well as the gap between the more distal airway model 302 and the rigid porous foam 301 provide locations at which one or more modules—such as cell cultures, sampling devices, probes, or sensory devices, and the like, of appropriate dimension and shape can be placed (not shown).

An alternative embodiment of a position pump 400, comprising three individual rigid porous foams, is shown in FIG. 4. Elements of the pump body, the more proximal airway model, of the radial walls of the rigid porous foams, of the gaskets or O-rings and of the gaps between the individual elements are in function and structure identical to what is described for the piston pump embodiment 300 shown in FIG. 3. The presence of three individual rigid porous foams 401a, 401b and 401c provides for the introduction of more locations at which one or more modules—such as one or more sensory devices, sampling devices or cell cultures, and the like, can be inserted and simultaneously allows fine tuning the properties of the overall model of the distal airways and the alveoli by incorporating foams of, for instance, different pore sizes, porosities or materials. The piston pump 400 has cylinder walls 403, a base plate 404 and a piston 405. The base plate 404 provides a centrally located opening 406 through which an airway model 407 such as the one described in WO2020/148238 is connected. The airway model 407 provides a proximal opening 408 to which models of one or more further proximal airways, for instance a bronchus, can be connected, if required. The opening of the more proximal airway model 407 bifurcates dichotomously to end in a defined number of smaller, distal openings at or in close proximity to the inner plane of the piston pump base plate 404. Optionally, the base plate 404 of the piston pump provides further openings 409, through which one or more sensors, probes, electronic connections or microfluidic or mesofluidic connections can be inserted. A plurality of such openings or one single opening may be present. The openings provide a structure that seals the internal volume of the pump air-tightly from the surroundings. Such structures are well described in the art and may, in the simplest case, comprise a perforated silicon plug through which the connections pass and which seals the perforation in the pump base plate 404. Optionally, the base plate 404 of the piston pump may provide still further openings 410 through which the foams 401a, 401b and 401c and/or the structure 402 can be connected to a supply of aqueous solution or liquid—such as water, and/or to a drain for the aqueous solution or liquid and/or to electronics needed for, for example, heating and/or monitoring temperature. The rigid porous foams 401a, 401b and 401c are located centrally within the piston pump and mounted, for instance, by screws 411 projecting through the walls 412 of the foams 401a, 401b and 401c, the disc-shaped structure 402 and the base plate 404. The screws may, for instance, catch in nuts 413 by means of which the foams 401a, 401b and 401c and the disc-shaped structure 402 are pressed towards the base plate 404. In the depicted embodiment, the radial wall 412 of the foams 401a, 401b and 401c are preferably of a different texture and/or of a different material than the core of the rigid porous foam. For example, the radial wall 412 may be made of the same ceramic or metallic material as the core of the foams 401a, 401b and 401c but does not provide macropores but only micropores and/or nanopores and hence does not conduct aerosols or gases and provides a high capillarity. Alternatively, the radial wall 412 of the foams 401a, 401b and 401c may be made of a synthetic material—such as an epoxy resin or a metal. The radial wall 412 as depicted in FIG. 4 provides the mechanical stability for fixing the rigid porous foam by means of the screws 411, but alternative embodiments may omit the radial wall 412 for the sake of increasing the total cross-sectional area of the flow path through the foam. The contact between the rigid porous foams 401a, 401b and 401c and the disc-shaped structure 402 and between the disc-shaped structure 402 and the pump base plate 404 may, for instance, be sealed by gaskets or O-rings 414. In this configuration, a suction stroke of the piston 404 forces gases and aerosol through the more proximal airway model 407, and the distal airway and alveolar model consisting of the foams 401a, 401b and 401c and the distal airway model 402 into the pump cylinder, a compression stroke of the piston forces gases and aerosols present within the pump through the foams 401a, 401b and 401c, the distal airway model 402 and the more proximal airway model 407. Between the pump base plate 404 or the more proximal airway model 406 and the more distal airway model 402, as well as between the more distal airway model 402 and the rigid porous foams 401a, 401b and 401c, the gaskets or O-rings 414 introduce gaps 415. The gap between the more proximal airway model 406 and the more distal airway model 402 serves to connect the channels present in the two models, as they are not necessarily located at radially and tangentially the same locations in the two models. The gap between the more distal airway model 402 and the rigid porous foams 401a, 401b and 401c serve to uniformly connect the rigid porous foam to the channels present in the airway model, i.e. to avoid the entry of the test agent into the foams 401a, 401b and 401c to be locally limited to the locations of the channels present in the more distal airway model 402. In addition, the gaps 415 between the pump base plate 404 or the more proximal airway model 406 and the more distal airway model 402, as well as the gap between the more distal airway model 402 and the rigid porous foams 401a, 401b and 401c provide locations at which one or more modules—such as one or more cell cultures, sampling devices, probes, or sensory devices, and the like, of appropriate dimension and shape can be placed (not shown).

An embodiment of the connection between the supply of aqueous solution or liquid to the rigid porous foam or of the connection between the drain for aqueous solution or liquid present in the micropores and/or nanopores of the rigid porous foam is shown in FIG. 5. The figure shows an enlarged section of a cross-sectional view of a lung model 500 containing the distal airway and alveolar model. In the depicted embodiment, the radial wall 501 for the rigid porous foam 502 is made of a porous material (for example, the same material as the rigid porous foam itself) but it does not contain macropores but only micropores and/or nanopores. The micropores and/or nanopores form a continuous porous connection between the rigid porous foam and the pump volume located between the pump cylinder wall and the distal airway and alveolar model. A bridging structure 503 providing connectivity to, for example, a microfluidic or mesofluidic tubing 504 originating at the reservoir of aqueous solution or liquid located outside the pump. The bridging structure may, for instance, be glued or welded to the surface of the radial wall 501 of the rigid porous foam. Alternatively, it can be part of the 3D-printed design of the rigid porous foam. The bridging structure 503 preferably provides an inner cavity 505 increasing the contact area between the fluid present within the bridging structure 503 and the radial wall 501 of the rigid porous foam. Connection with the microfluidic or mesofluidic system establishes constant supply of aqueous solution or liquid, driven by the capillary action of the micropores and/or nanopores of the foam, the evaporation of water inside the rigid porous foam and/or the negative pressure applied at the drain. With the aqueous solution or liquid in the microfluidic or mesofluidic tubing set to an appropriate negative pressure relative to the surrounding air, the capillarity of the micropores and/or nanopores present in the radial wall 501 of the rigid porous foam 502 and the struts of the rigid porous foam prevents or reduces air from entering the micropores and/or nanopores and establishes an aqueous or liquid continuum reaching from the reservoir through the microfluidic or mesofluidic tubings of the supply, the micropores and/or nanopores of the distal airway and alveolar model and the microfluidic or mesofluidic tubings of the drain to the reservoir of the drain.

An alternative possible embodiment of the connection between the supply of aqueous solution or liquid to the rigid porous foam or of the connection between the drain for aqueous solution or liquid present in the micro-/nanopores of the rigid porous foam is shown in FIG. 6. This figure shows an enlarged section 600 of the cross-sectional view of a lung model containing an embodiment of the distal airway and alveolar model in which the hierarchical rigid porous foam 601 is not surrounded by a radial wall but is permissible to gases or aerosols on its complete surface. Such an embodiment cannot be connected to a source and/or drain of aqueous solution or liquid in the way shown in FIG. 5, because the direct connection of the aqueous solution or liquid with the macropores of the rigid porous foam eliminates the closed contact between the capillary activity of the micropores and/or nanopores which results in the intake of air into the aqueous or liquid circuit. To overcome this limitation, a microporous and/or nanoporous bridge between the aqueous or liquid circuit and the rigid porous foam is required. This can be established, for instance, by providing a bridging structure 602, which can, for instance, be glued or welded to the rigid porous foam 601, or which can be part of the 3D printed design of the foam. The bridging structure 602 allows connecting the aqueous or liquid circuit (supply or drain of aqueous solution or liquid) by means of microfluidic or mesofluidic tubings 603. The microporous and/or nanoporous bridge 604 is inserted into the bridging structure 602 so it establishes contact to the rigid porous foam 601. The microporous and/or nanoporous bridge can, for instance be composed of a fibrous or spongy material (for example, cellulose acetate) and is preferably flexible and easily deformed so it adapts its shape to the shape of the rigid porous foam at the site of connection and thereby maximizes the contact area to the microporous and/or nanoporous network in the foam. A bridge made of dense bundles of cellulose acetate fibers in the length of about 2 cm was successfully tested in combination with an alumina ceramic hierarchical rigid porous foam with a macropore density of 45 pores per inch, an average macropore size of 820 μm and a micropore and/or nanopore size below 30 μm. The bridge could maintain a closed aqueous or liquid circuit at a negative pressure of more than 2000 Pascal and allowed for continuous, evaporation-driven supply of water to the alumina foam.

In a further aspect, there is described a system for determining the interaction between a test atmosphere and a simulated respiratory tract, said system comprising: (a) a first pump comprising: (i) a chamber configured for containing a first volume of gas comprising a test atmosphere; (ii) a first port adapted for receiving and outputting gas and comprising a valve for regulating the flow of gas through the first port, said valve being moveable between open and closed positions, wherein in the open position said valve is openable towards a test atmosphere or surrounding air; (iii) a second port adapted for outputting and receiving gas and comprising a valve for regulating the flow of gas through the second port, said valve being moveable between open and closed positions; and (iv) a motor for controlling the operation of the first pump; (b) a second pump comprising: (i) a chamber configured for containing a second volume of gas, wherein the first and second volumes of gas are different; (ii) a port adapted for receiving and outputting gas; (iii) a piston plate in the chamber, said piston plate comprising one or more apertures for the uptake or inflow of gas into the chamber wherein one or more, or each, of the apertures include a valve that is movable between open and closed positions and is capable of regulating the uptake or inflow of gas; and (iv) the airway and alveoli model of the present disclosure housed inside the second pump; and (iv) a motor for controlling the operation of the second pump; (c) a connecting structure operable to transmit the gas from the first pump into the second pump; and (d) one or more openings in the first pump or the second pump or the walls of the connecting structure or a combination of two or more thereof, said openings being capable of receiving a module for containing or storing a matrix comprising a cell culture medium and/or at least one microsensor for monitoring conditions in the chamber or for gas sampling or for gas characterisation.

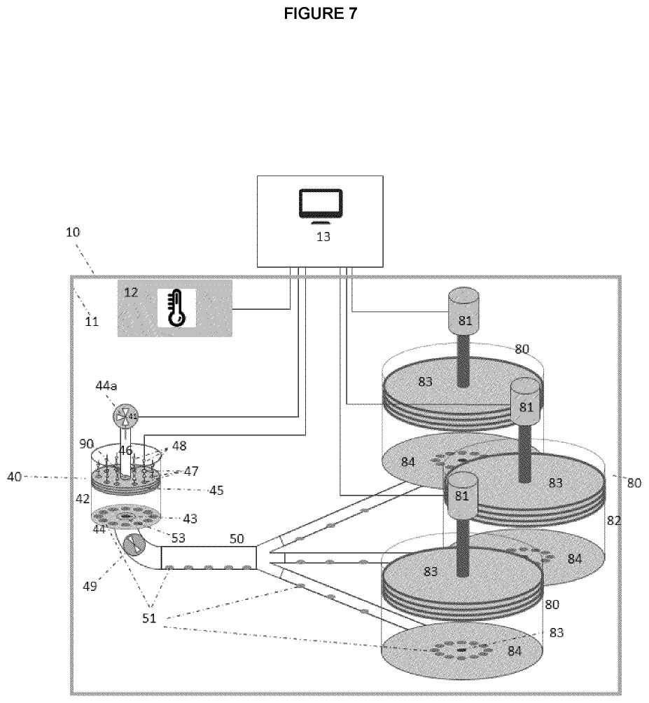

The gas can be a test atmosphere or it can comprise a test atmosphere. FIG. 7 illustrates a system 10 according to this aspect of the present disclosure. The system 10 includes at least two pumps 40, 80. The two or more pumps 40, 80 are connected to each other. In certain embodiments, the two or more pumps 40, 80 are connected to each other by a branched hollow structure 50. Each pump 40, 80 can be operated by its own individual motor 41, 81 or two or more pumps can be operated by the same motor 41, 81, as required. The complete system 10 can be located in a climatic housing 11 equipped with a thermostat 12 to control the temperature in the housing 11. The chambers of the pumps 40, 80 can be configured to represent the internal volumes of different compartments of a respiratory tract-such as a human or animal respiratory tract. They can be configured to provide a displacement volume at least as large as the maximally achievable volume uptake in the respective compartment of the respiratory tract. In particular, one (first) pump 40 can represent the volume of the oral and oropharyngeal cavity—such as a human or animal oral and oropharyngeal cavity. Another second pump 80 can represent the volume of the lung lumen or parts thereof—such as the lumen of individual lung lobes or smaller subunits, especially human or animal lung lumen or parts thereof. The airway and alveoli model of the present disclosure can be housed inside the second pump 80. The branched hollow connecting structure 50 can represent the dimensions of the conducting airways—such as one or more of the nasopharyngeal cavity, hypopharynx, larynx, trachea, bronchi and bronchiolar structures down to the respiratory bronchioles, especially human or animal conducting airways. The branched hollow connecting structure 50 can represent the dimensions of the conducting airways—including the nasopharyngeal cavity, hypopharynx, larynx, trachea, bronchi and bronchiolar structures down to the respiratory bronchioles. The dimensions, for example, the diameters and lengths, as well as the branching pattern of the different sub-parts of the connecting structure 50 can resemble the tree of conducting airways.

The branched hollow structure 50 can be connected to a central opening 43, 83 in the base 44, 84 of the chamber 42, 82 of each pump 40, 80. In certain embodiments, multiple openings, holes or sockets 51 can be present on the base 44, 84 of the chamber(s) 42, 82, which may be arranged symmetrically around the central opening 43, 83. Directly at the connection between the pump 40 and the connecting structure 50, a valve 44a can be used to allow sealing of the pump 40 from all other system parts. The pump 40 representing the oral cavity can have one or more opening(s) 43 through which test atmosphere(s) and dilution air can leave the pump 40 towards the branched hollow structure 50. The point of entry and exit of a test atmosphere 90 is typically located on the piston plate 45 of the pump 40, suitably in the centre thereof. It can run through a hollow piston axis 46, on top of which a valve 44a—such as a three-way valve can be present. In embodiments, the valve 44a can be closed or opened towards a test atmosphere source or surrounding air. An array of one or more (for example, a plurality) apertures 47 through which surrounding air can enter the system is arranged on the piston plate 45, optionally in a radial arrangement. One or more valves 48 (for example, a plurality) on one or more, or all, of the apertures can be used to allow the opening or closing of one or more of these apertures 47. In certain embodiments, each aperture 47 is controlled by a valve 48. In certain embodiments, an array of one or more (for example, a plurality) apertures through which surrounding air can enter the system can be arranged on the piston plate 84 of the second pump, optionally in a radial arrangement. One or more valves (for example, a plurality) can be used to allow the opening or closing of one or more of these apertures. In certain embodiments, each aperture is controlled by a valve. In certain embodiments, an array of one or more (for example, a plurality) apertures through which surrounding air can enter the system can be arranged on the piston plate of the first and second pump, optionally in a radial arrangement. Advantageously, the branched hollow structure 50 can be disconnected from the pumps 40, 80. Advantageously, the branched hollow structure 50 can be disassembled to its primary parts. This can allow easy access for placing or removing test systems and/or for cleaning. The bases 44, 84 of the pumps 40, 80 can be removed for placing/removing test systems and for cleaning. In the base 44, 84 of each pump 40, 80 as well as in the different parts of the connecting structure 50, openings, holes or sockets 51—such as threaded or non-threaded openings, threaded or non-threaded holes or threaded or non-threaded sockets 113, 213—can be located therein. The openings, holes or sockets 51 can be located in various positions—such as on the bases 44, 84 of one or more of the pumps 40, 80, or they can be arranged around the central opening 43, 83 or in the branched hollow structure 50 at various locations of choice, suitably on the lower side of the branched hollow structure 50 or any combination thereof. The openings, holes or sockets 51 can be used to allow mounting of various modules 112, 212 or devices therein or thereon which can be used to monitor the operation of the system 10 and/or to conduct experiments and/or to collect samples and the like. Examples of such modules are described herein. Advantageously, the pumps 40, 80 that are used in the system 10 are therefore able to function not only to transport test atmospheres but they can also function as exposure chambers. Modules that are used can be adapted for various purposes depending on the requirements of the system being configured. For example, modules can be adapted to contain or store a cell culture medium or for monitoring conditions in the chamber 42, 82 or for gas or liquid sampling or for gas characterisation and the like. The modules can be located on the base 44, 84 of the first 40 and/or second 80 pump and/or in the walls of the connecting structure 50. In a particular embodiment, the one or more modules can be configured to contain or store a matrix comprising cell culture medium. According to this embodiment, the one or more modules can be receptacles capable of holding a liquid or solution. The cell culture medium can comprise or it can be in contact with a culture of cells—such as a 2- or 3-dimensional culture of cells. In certain embodiments, the one or more modules can be capable of holding or locating at least one microsensor, either as an alternative or in addition to a cell culture medium matrix. In certain embodiments, the module(s) adapted for containing or storing a matrix comprising a cell culture medium and/or at least one microsensor further comprise a microfluidic channel and optionally a microfluidic pump connected thereto. The modules will generally be positioned in a horizontal plane in one or more of the first pump 40 or the second pump 80 or the walls of the connecting structure 50.

Test atmospheres—such as gases and aerosols—can be studied and can be generated via various means. For many applications, for example, for testing tobacco products or common medical inhalers and the like, the test atmosphere generation can be driven by pumps that may be present in the respiratory simulator to generate the negative pressure required for generation and extraction of the test atmosphere, which means that the use of aerosol generators/smoking machines is advantageously not required. The test atmosphere can be an aerosol—such as smoke or it can be derived from smoke. As used herein, the term ‘smoke’ is used to describe a type of aerosol that is produced by smoking articles, such as cigarettes, or by combusting an aerosol forming material. Smoke includes various agents, which can be provided as individual compounds for study if required. Examples of such agents include nicotine-free dry particulate matter, carbon monoxide, formaldehyde, acetaldehyde, acetone, acrolein, propionaldehyde, crotonaldehyde, methyl-ethyl ketone, butyraldehyde, benzo[a]pyrene, phenol, m-cresol, o-cresol, p-cresol, catechol, resorcinol, hydroquinone, 1,3-butadiene, isoprene, acrylonitrile, benzene, toluene, pyridine, quinoline, styrene, N′-nitrosonornicotine (NNN), N′-nitrosoanatabine (NAT), N′-nitrosoanabasine (NAB), 4-(methylnitrosamino)-1-(3-pyridyl)-1-butanone (NNK), 1-aminonaphthalene, 2-aminonaphthalene, 3-aminobiphenyl, 4-aminobiphenyl, nitrogen monoxide (NO), nitrous oxide (NOx), cyanhydric acid, ammonia, arsenic, cadmium, chrome, lead, nickel, selenium and mercury.

When the aerosol is smoke, a smoking machine can be used to generate the aerosol. The smoking machine may be attached to the respiratory simulator. Thus, the smoking machine holds and lights cigarettes and the aerosol is provided directly to the respiratory simulator. A defined number of puffs per cigarette and a defined number of puffs per minute of exposure can be used and the number of cigarettes varied to adjust to the exposure times. Reference cigarettes—such as the reference cigarettes 3R4F—can be used as the source of the smoke and smoked on the smoking machine in basic conformity with the International Organization for Standardization smoking regimen (ISO 2000).

The use of a control atmosphere is also contemplated—such as an atmosphere that does not contain the test atmosphere. The use of the control atmosphere can help to determine the effect of the test atmosphere in comparison to the control atmosphere.

A respiratory simulator can be connected to a smoking machine by means of a suitable conduit, which provides a flow path for the smoke to the respiratory simulator. The smoke may be transferred through the conduit with or without a carrier gas, such as air. Where a carrier gas is used, the conduit preferably comprises an inlet for the introduction of the carrier gas into the conduit, to mix with the smoke stream. The conduit can comprise at least one inlet for the introduction or injection of a standard reference into the respiratory simulator—such as nicotine—for the purposes of calibration. The smoke flow will generally be controlled by the respiratory simulator.

The smoking machine may be a linear or rotary smoking machine. Suitably, the smoking machine is operated to smoke a plurality of smoking articles simultaneously such that the cumulative smoke from the plurality of smoking articles can be collected and analysed. Suitable smoking machines for use in the present disclosure are well known to the skilled person.

The present disclosure can be used to perform an analysis of the mainstream smoke generated by a smoking article during the smoking test. The ‘mainstream smoke’ refers to the smoke that is drawn through the smoking article and which would be inhaled by the consumer during use.

The test atmosphere may be from an ‘aerosol-generating device’, which is a device that interacts with an aerosol-forming substrate to generate an aerosol. An example of an aerosol is smoke. The aerosol-forming substrate may be part of an aerosol-generating article. An aerosol-generating device may comprise one or more components suitable for generating an aerosol from an aerosol generating substrate. An aerosol-generating device may be an electrically heated aerosol-generating device, which is an aerosol-generating device comprising a heater that is operated by electrical power to heat an aerosol-forming substrate of an aerosol-generating article to generate an aerosol. The aerosol-generating device may be a gas-heated aerosol-generating device, a device heated by a carbonaceous heat source, other exothermal chemical reaction, or a heat sink. Other suitable means to generate an aerosol are well known in the art. An aerosol-generating device may be a device that interacts with an aerosol-forming substrate of an aerosol-generating article to generate an aerosol that is directly inhalable into a user's lungs thorough the user's mouth.

Another example of an ‘aerosol-generating device’ is an inhalation device (inhaler) which is generally used to deliver an aerosol containing an active ingredient—such as a medically active compound. Such inhalation devices are generally used for the delivery of aerosolised medicaments to the respiratory tract. They can be used for the treatment of respiratory and other diseases. Such inhalers are well known in the art and are generally of the pressurised metered type, the dry powder type or the nebulizer type. Generally, the medicament is in the form of a pressurized formulation containing fine particles of one or more medicinal compounds suspended in a liquefied propellant, or a solution of one or more compounds dissolved in a propellant/co-solvent system. Such formulations are well known in the art.

As used herein, the term ‘aerosol-forming substrate’ relates to a substrate capable of releasing volatile compounds that can form an aerosol. Such volatile compounds may be released by heating the aerosol-forming substrate. An aerosol-forming substrate may be adsorbed, coated, impregnated or otherwise loaded onto a carrier or support. An aerosol-forming substrate may conveniently be part of an aerosol-generating article or smoking article. In certain applications, the aerosol-forming substrate is contained in an aerosol-generating article, for example a rod-shaped aerosol-generating article such as a heated aerosol-generating article or heated cigarette. The aerosol-generating article is of suitable size and shape to engage with the aerosol-generating device so as to bring the aerosol-forming substrate into contact with the heater.

An aerosol-forming substrate may comprise medically active compounds or medicaments-such as antibiotics or anti-inflammatory agents that can be delivered to a patient via the respiratory tract. Numerous medical inhalation devices (inhalers) are known and routinely prescribed for treating various respiratory tract related and non-respiratory tract related diseases.

An aerosol-forming substrate may comprise nicotine. An aerosol-forming substrate may comprise tobacco. The aerosol-forming substrate may comprise, for example, a tobacco-containing material containing volatile tobacco flavour compounds, which are released from the aerosol-forming substrate upon heating. In certain embodiments, an aerosol-forming substrate may comprise homogenised tobacco material, for example cast leaf tobacco. As used herein, “homogenised tobacco material” refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise comminuting one or both of tobacco leaf lamina and tobacco leaf stems. Alternatively, or in addition, sheets of homogenised tobacco material may comprise one or more of tobacco dust, tobacco fines and other particulate tobacco byproducts formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibers, aerosol-formers, humectants, plasticisers, flavourants, fillers, aqueous and non-aqueous solvents and combinations thereof.

Cell cultures for use in the present disclosure include 2-dimensional and 3-dimensional cell cultures. As described herein, the cell culture can be contained in one or more of the foams.

The cell culture can be exposed to a test atmosphere such that the effect of the test atmosphere on the cell culture can be determined. Two or more cell cultures can be located at different positions in the rigid porous foam so that the effect of the test atmosphere on the cell cultures at these different locations—which mimic the respiratory tract—can be determined. 2-dimensional cell culture involves growing cells in flat layers on plastic surfaces which permits the study of several aspects of cellular physiology and responses to stimuli—such as test atmosphere(s), but they do not reflect the real structure and architecture of an organ. In 2-dimensional monolayers, the extracellular matrix, the cell-to-cell and cell-to-matrix interactions, which are essential for the differentiation, proliferation and cellular functions are lost. 3-dimensional culture systems can form a functional tissue with similar features to those observed in vivo. As compared to the 2-dimensional culture systems, 3-dimensional cell culture allows cells to interact with their surroundings in all three dimensions and are more physiologically relevant. Such cells can show improvements in viability, proliferation, differentiation, morphology, response to stimuli, drug metabolism, gene expression and protein synthesis and the like. 3-dimensional cell culture can produce specific tissue-like structures and mimic functions and responses of real tissues in a manner that is more physiologically relevant than traditional 2-dimensional cell monolayers. Several 3-dimensional tissues mimicking human organs are commercially available. Lung 3-dimensional organotypic tissues can be prepared using primary human cells grown at an air-liquid interface (ALI) where these cells will differentiate and form a functional tissue. These 3-dimensional tissues bear close morphological resemblance and metabolic characteristics to human bronchial tissues. They are composed of basal, goblet and ciliated cells arranged in a pseudostratified structure. Similar to the lung, actively beating cilia are present allowing the study of their function and activity. Similar levels of xenobiotic enzyme-encoding mRNA have been found in these 3-dimensional ALI cultures compared with human lungs. In addition, these tissues can be maintained in vitro for an extended period of time.

This distal airway and alveolar model is an appropriate model to explore the effects of test atmospheres and the like in accordance with the present disclosure. The term ‘3-dimensional cell culture’ includes any method that provides for the culture of a cell in 3 dimensions, with or without the use of a matrix or scaffold. A number of different 3-dimensional cell culture methods have been developed including, spheroid cultures and organotypic cultures.

Cells for use in the present disclosure can be isolated from a tissue or a fluid using methods that are well known in the art. They can be differentiated from stem cells—such as embryonic stem cells or induced pluripotent stem cells, or directly differentiated from somatic cells. Cells and cell lines may be or may be derived from human or animal subjects or from human or animal cells, including any of a number of mammalian species, suitably human, but including rat, mouse, pig, rabbit, and non-human primates and the like. Cells and cell lines can be obtained from commercial sources. In certain embodiments, the use of human cells is desirable. Lung cells—including lung epithelial cells—are a cell type of interest. Bronchial and/or airway epithelial cells can be used in the present disclosure. Human bronchial epithelial cells can be collected by brushing donor lungs during a bronchoscopy procedure. In one embodiment, the lung cells are Normal Human Bronchial Epithelial (NHBE) cells. The lung epithelial cells can be cultured as a monolayer of undifferentiated cells or further developed into an organotypic lung epithelium-like tissue at an air-liquid interface. Cells can be established at an air-liquid interface using the following methodology. Briefly, epithelial cells can be cultured in a flask to increase the number of cells. After a period of incubation, cells are detached from the flask, counted and seeded onto inserts. On these inserts, cells are incubated with medium on the apical and basal sides. This phase ensure that the cells will divide and completely cover the insert to form an epithelium. Then, apical medium is removed, the basal medium is retained and replaced with a more complete medium. Cultures are incubated like this for a further period of time. In the meantime, the cells will differentiate into 3 cell types: basal, goblet and ciliated cells. At the end of the maturation, the cultures are ready to use. The use of the air liquid interface to culture human nasal epithelial cells is described in J Vis Exp. (2013), 80, 50646. Lung epithelial cells can be obtained from human or animal subjects with different pathologies, including subjects that are classified as smokers or non-smokers.

Airway and alveoli cell culture is reviewed in European Respiratory Journal (2019) 54: 1900742. Adult tracheal, bronchial and small airway epithelial cells can be isolated from donor lungs obtained from transplant programmes, from surgically resected tissue, or from bronchial brushes obtained during bronchoscopy. Nasal epithelial cells can be obtained by nasal brushing. Airway epithelial cells are commercially available as frozen vials or cultures from companies—such as Lonza and Epithelix. Epithelial cells can be dissociated by protease treatment (to detach the cells from each other and the extracellular matrix, and from unwanted cells). Selective media can be used to inhibit outgrowth of other cell types—such as fibroblasts. Most procedures utilise cells submerged in medium and cultured tissue culture plastic that is coated with extracellular matrix—such as collagens. Culturing epithelial cells in Transwells on microporous membranes at an air-liquid interface promotes airway basal epithelial cell differentiation into a mucociliary epithelial culture that resembles the airway epithelium in situ, whilst enabling relevant exposure protocols to study airborne substances. Alveolar epithelial cells can be collected from adult lung tissue from normal-appearing tissue following surgery. Isolation of AEC2 typically includes additional steps—such as differential adherence and magnetic bead sorting—to separate these AEC2s from other cells, such as macrophages and fibroblasts. Primary alveolar epithelial cells are also available from commercial suppliers. Culturing lung epithelial cells in Transwells allows culture at the air-liquid interface. Epithelial cells can also be grown on a layer of collagen in which fibroblasts are embedded. A variety of methods can be used to characterise epithelial cell cultures based on structure, morphology and expression of unique cell-specific markers, including electron and confocal microscopy, immunostaining and gene expression analysis by RT-PCR. Unique functional characteristics include ciliary beat frequency for airway cells, and surfactant synthesis for AEC2. Alveolar epithelial cells have been derived from induced pluripotent stem cells (iPSCs) and are capable of forming 3D structures under organotypic culture (see for example Elife, 4 (2015), p. e05098; Stem Cell Rep., 3 (2014), pp. 394-403; Cell Stem Cell, 21 (2017), pp. 472-488.e10 and Nat. Methods, 14 (2017), pp. 1097-1106). iScience (2022), 25, 2, 10378 describe alveolar epithelial-derived distal lung cell lines.

3-dimensional lung epithelial cells have been obtained from airway basal cells (see Proc Natl Acad Sci USA (2009) 106, 12771-5) and from alveolar cells (see J Clin Invest (2013) 123, 3025-3036) and from iPSC-derived airway or alveolar cells (see Development (2017), 144, 986-997 and Curr Pathobiol Rep (2017) 5, 223-231).

The present disclosure can be used for a variety of applications for studying the impact of a test atmosphere(s) on terminal, transitional and respiratory bronchioles, and/or on the alveolar ducts and/or on the alveolar spaces of a respiratory tract, and optionally other parts of the respiratory tract as required. For example, the present disclosure can be used in the study of in vitro inhalation toxicology in one or more of bronchioles and/or alveolar ducts and/or the alveolar spaces of a respiratory tract. For example, the present disclosure can be used to the investigate aerosol dynamics for example, aerosol particle deposition and absorption of gases into cell cultures) or investigation of metabolic activity or transport of a test atmosphere(s) (for example, aerosol molecules) across bronchioles and/or alveolar ducts and/or the alveolar spaces of a respiratory tract. The present disclosure can be used for testing the effect of aerosol(s), smoke or tobacco products or the effect of inhalers—such as medical inhalers. The present disclosure can be used for testing the effect of aerosol(s), smoke or tobacco products or the effect of medical inhalers on cells of one or more parts of the respiratory tract.

One aspect relates to a method for determining the effect of a test atmosphere on a culture of cells—such as one or more cultures of cells—contained in a simulated respiratory tract comprising: (a) providing the respiratory simulator as described herein, wherein the system contains a culture of cells; and (b) comparing the culture of cells before and/or after exposure to the test atmosphere, wherein a difference between the culture of cells before and/or after exposure of the cells to the test atmosphere is indicative that the test atmosphere effects the culture of cells.

In the embodiment where a difference between the culture of cells is determined after exposure of the cells to the test atmosphere, the culture of cells exposed to the test atmosphere can be compared to a culture of cells that have not been exposed to a test atmosphere or to a culture of cells that is exposed to a control atmosphere—such as an atmosphere that does not contain the test atmosphere. According to this embodiment, a difference between the culture of cells exposed to the test atmosphere and the culture of cells not exposed to the test atmosphere or a difference between the culture of cells exposed to the test atmosphere and a culture of cells exposed to a control atmosphere—such as an atmosphere that does not contain the test atmosphere—is indicative that the test atmosphere effects the culture of cells.

The effect of the test atmosphere(s) may be studied in the presence of one or more agents.

The agent(s) can include, but are not limited to, a drug, a toxin, a pathogen, a protein, a nucleic acid, an antigen, an antibody, and a chemical compound etc. Examples of the effects that can be measured include consumption of oxygen, production of carbon dioxide, cell viability, expression of a protein, enzyme activity, penetration, permeability barrier function, surfactant production, response to cytokines, transporter function, cytochrome P450 expression, albumin secretion, toxicology and the like.

A plurality of assays may be run in parallel with different concentrations of the test atmosphere and/or agent to obtain a differential response to the various concentrations.

The agent may be any test compound of interest and includes small organic compounds, polypeptides, peptides, higher molecular weight carbohydrates, polynucleotides, fatty acids and lipids, aerosol or one or more components of an aerosol and the like. Test compounds may be screened individually or in sets or combinatorial libraries of compounds. Test compounds can be obtained from a wide variety of sources including libraries of synthetic or natural compounds. Libraries of natural compounds in the form of bacterial, fungal, plant and animal extracts can be used. Natural or synthetically produced libraries and compounds that are modified through conventional chemical, physical and biochemical means may be used to produce combinatorial libraries. Known pharmacological agents may be subjected to directed or random chemical modifications, such as acylation, alkylation, esterification, acidification to produce structural analogues for screening.

One or more variables that can be measured include elements of cells, subcellular material, subcellular components, or cellular products. By way of example, the toxicology of the test atmosphere can be measured. The aerosol dynamics (for example, aerosol particle deposition and absorption of gases into cell cultures) can be measured. By way of further example, the metabolic activity and/or the transport of molecules can be studied.

Further aspects of the present disclosure are set forth in the following numbered paragraphs:

1. A respiratory simulator comprising a rigid porous foam, the rigid porous foam comprising an interconnected open-celled network of: (i) macropores; and (ii) micropores and/or nanopores.

2. The respiratory simulator according to paragraph 1, wherein the rigid porous foam is: (i) a ceramic or a metallic rigid porous foam; or (ii) a ceramic and a metallic rigid porous foam.

3. The respiratory simulator according to paragraph 2, wherein the rigid porous foam is made of alumina or silicon carbide or oxygen bonded silicon carbide or sintered silicon carbide or a combination of two or more thereof.

4. The respiratory simulator according to any of the preceding paragraphs, wherein the rigid porous foam contains walls and struts and wherein the struts of the rigid porous foam contain micropores and/or nanopores and the walls of the macropores of the rigid porous foam are covered with the micropores and/or nanopores that open towards the macropores.

5. The respiratory simulator according to any of the preceding paragraphs, wherein the macropores are capable of conducting a gas or an aerosol supplied to the rigid porous foam.

6. The respiratory simulator according to any of the preceding paragraphs, wherein the micropores and/or nanopores are capable of: (i) conducting an aqueous solution or liquid supplied to the rigid porous foam; and (ii) retaining the aqueous solution or liquid within the micropores and/or nanopores.

7. The respiratory simulator according to any of the preceding paragraphs, wherein: (i) the macropores contain a gas or an aerosol; or (ii) the micropores and/or nanopores contain an aqueous solution or liquid; or (iii) the macropores contain a gas or an aerosol and the micropores and/or nanopores contain an aqueous solution or liquid.

8. The respiratory simulator according to paragraph 7, wherein the aqueous solution or liquid present within the micropores and/or nanopores forms an aqueous or liquid layer covering a portion or all of the surface of the macropores.

9. The respiratory simulator according to any of the preceding paragraphs, wherein the rigid porous foam contains a first connector capable of establishing a leak-tight connection with the respiratory simulator.

10. The respiratory simulator according to any of the preceding paragraphs, wherein the rigid porous foam contains a second connector capable of connecting the rigid porous foam to a source of aqueous solution or liquid.

11. The respiratory simulator according to any of the preceding paragraphs, wherein the rigid porous foam contains a third connector capable of connecting the rigid porous foam to a drain.

12. The respiratory simulator according to any of the preceding paragraphs, comprising one or more cavities or sockets or indentations or a combination of two or more thereof in the rigid porous foam, wherein the one or more cavities or sockets or indentations or a combination of two or more thereof are capable of accepting one or more sensory devices or probes or sampling devices or cell cultures.

13. The respiratory simulator according to paragraph 12, wherein the one or more cavities or sockets or indentations or a combination of two or more thereof contain the one or more sensory devices probes or sampling devices or cell cultures.

14. The respiratory simulator according to any of the preceding paragraphs, wherein the rigid porous foam comprises one or more bifurcated channels, suitably, wherein the bifurcated channel(s) bifurcate dichotomously, more suitably, wherein the rigid porous foam forming the bifurcated channel(s) contains micropores and/or nanopores.

15. The respiratory simulator according to any of the preceding paragraphs, wherein the interconnected network of macropores and micropores and/or nanopores comprises:
(i) pairs of macropores connected by a continuous channel formed by the macropores; and
(ii) pairs of micropores and/or nanopores connected by a continuous channel formed by the micropores and/or nanopores; and
(iii) micropores and/or nanopores connected to any macropore by a continuous channel formed by the micropores and/or nanopores and the macropores.

16. The respiratory simulator according to any of the preceding paragraphs, wherein the radius of the macropores is between about 0.1 to about 0.4 mm, or between about 0.1 to about 0.3 mm, or between about 0.2 to about 0.4 mm, or between about 0.2 to about 0.3 mm or between about 200 μm and about 2000 μm in diameter, or about 820 μm±150 μm in diameter.

17. The respiratory simulator according to any of the preceding paragraphs, wherein the radius of the micropores and/or nanopores is between about 0.01 μm and about 50 μm in diameter, suitably, below about 30 μm, or between about 0.25 μm and about 25 μm.

18. The respiratory simulator according to any of the preceding paragraphs, wherein the total surface area of the rigid porous foam is at least about 70 square metres, suitably at least about 100 square metres.

19. The respiratory simulator according to any of the preceding paragraphs, comprising at least two rigid porous foams each of different pore size distribution or each of different porosity or each of a different material.

20. The respiratory simulator according to any of paragraphs 7 to 19, wherein the aqueous solution or liquid below the surfaces spanning the micropores and/or nanopores has a negative pressure relative to the environment that is larger in absolute value than the negative pressure, in absolute value and relative to the environment, below the aqueous solution or liquid surfaces spanning the macropores.

21. The respiratory simulator according to any of the preceding paragraphs, wherein the rigid porous foam has a cylindrical shape or a disc shape or a cuboid shape.

22. The respiratory simulator according to paragraph 21, wherein the cylindrically shaped or disc shaped or cuboid shaped rigid porous foam comprises a radial wall that is made of a different material to the rigid porous foam.

23. The respiratory simulator according to paragraph 22, wherein the different material does not contain macropores or wherein the different material is a synthetic material, preferably, an epoxy resin or a metal or a combination thereof.

24. The respiratory simulator according to any of the preceding paragraphs, wherein a bridging structure contacts the rigid porous foam, preferably wherein a bridge is joined to the bridging structure, preferably, wherein the bridge is flexible.

25. The respiratory simulator according to any of the preceding paragraphs, the respiratory simulator comprising a pump and wherein the rigid porous foam is contained inside the pump.

26. The respiratory simulator according to any of the preceding paragraphs, wherein the pump is a piston pump.

27. Use of a rigid porous foam for simulating the distal airways and alveoli in a respiratory simulator, the rigid porous foam comprising an interconnected open-celled network of: (i) macropores; and (ii) micropores and/or nanopores.

28. Use according to paragraph 27, wherein the rigid porous foam is: (i) a ceramic or a metallic rigid porous foam; or (ii) a ceramic and a metallic rigid porous foam.

29 Use according to paragraph 28, wherein the rigid porous foam is made of alumina or silicon carbide or oxygen bonded silicon carbide or sintered silicon carbide or a combination of two or more thereof.

30. Use according to any of paragraphs 27 to 29, wherein the rigid porous foam contains walls and struts and wherein the struts of the rigid porous foam contain micropores and/or nanopores and the walls of the macropores of the rigid porous foam are covered with the micropores and/or nanopores that open towards the macropores.

31. Use according to any of paragraphs 27 to 30, wherein the macropores are capable of conducting a gas or an aerosol supplied to the rigid porous foam.

32. Use according to any of paragraphs 27 to 31, wherein the micropores and/or nanopores are capable of: (i) conducting an aqueous solution or liquid supplied to the rigid porous foam; and (ii) retaining the aqueous solution or liquid within the micropores and/or nanopores.

33. Use according to any of paragraphs 27 to 32, wherein: (i) the macropores contain a gas or an aerosol; or (ii) the micropores and/or nanopores contain an aqueous solution or liquid; or (iii) the macropores contain a gas or an aerosol and the micropores and/or nanopores contain an aqueous solution or liquid.

34. Use according to paragraph 33, wherein the micropores and/or nanopores containing the aqueous solution or liquid form an aqueous or liquid layer covering a portion or all of the surface of the macropores.

35. Use according to any of paragraphs 27 to 34, wherein the rigid porous foam comprises one or more cavities or sockets or indentations or a combination of two or more thereof in the rigid porous foam, wherein the one or more cavities or sockets or indentations or a combination of two or more thereof are capable of accepting one or more sensory devices or probes or sampling devices or cell cultures.

36. Use according to paragraph 35, wherein the one or more cavities or sockets or indentations or a combination of two or more thereof contain the one or more sensory devices probes or sampling devices or cell cultures.

37. Use according to any of paragraphs 27 to 36, wherein the rigid porous foam comprises one or more bifurcated channels, suitably, wherein the bifurcated channel(s) bifurcates dichotomously, more suitably, wherein the bifurcated channel(s) is located in the micropores and/or nanopores.

38. Use according to any of paragraphs 27 to 37, wherein the interconnected network of macropores and micropores and/or nanopores comprises:
(i) pairs of macropores connected by a continuous channel formed by the macropores; and
(ii) pairs of micropores and/or nanopores connected by a continuous channel formed by the micropores and/or nanopores; and
(iii) micropores and/or nanopores connected to any macropore by a continuous channel formed by the micropores and/or nanopores and the macropores.

39 Use according to any of paragraphs 27 to 38, wherein the radius of the macropores is between about 0.1 to about 0.4 mm, or between about 0.1 to about 0.3 mm, or between about 0.2 to about 0.4 mm, or between about 0.2 to about 0.3 mm or between about 200 μm and about 2000 μm in diameter.

40. Use according to any of paragraphs 27 to 39, wherein the radius of the micropores and/or nanopores are between about 0.01 μm and about 50 μm in diameter or between about 0.25 μm and about 25 μm.

41. Use according to any of paragraphs 27 to 40, wherein the total surface area of the rigid porous foam is at least about 70 square metres, suitably at least about 100 square metres.

42. Use according to any of paragraphs 27 to 41, comprising at least two rigid porous foams each of different pore size distribution or each of different porosity or each of a different material.

43. Use according to any of paragraphs 33 to 42, wherein the aqueous solution or liquid below the surfaces spanning the micropores and/or nanopores has a negative pressure relative to the environment that is larger in absolute value than the negative pressure relative to the environment below the aqueous solution or liquid surfaces spanning the macropores.

44. Use according to any of paragraphs 27 to 43, wherein the rigid porous foam has a cylindrical shape or a disc shape or a cuboid shape.

45. Use according to paragraph 44, wherein the cylindrically shaped or disc shaped or cuboid shaped rigid porous foam comprises a radial wall that is made of a different material to the rigid porous foam.

46. Use according to paragraph 45, wherein the different material does not contain macropores or wherein the different material is a synthetic material, preferably, an epoxy resin or a metal or a combination thereof.

47. Use according to any of paragraphs 27 to 46, wherein a bridging structure contacts the rigid porous foam, preferably wherein a bridge is joined to the bridging structure, preferably, wherein the bridge is flexible.

48. Use according to any of paragraphs 27 to 47, wherein the respiratory simulator comprises a pump and wherein the rigid porous foam is contained inside the pump.

49. Use according to paragraph 48, wherein the pump is a piston pump.

50. A method for determining the effect of a test atmosphere on a simulated distal airway and alveoli of a mammalian respiratory tract comprising:
(i) providing the respiratory simulator according to any of paragraphs 1 to 26;
(ii) contacting the respiratory simulator with the test atmosphere; and
(iii) determining the effect of the test atmosphere on the simulated distal airway and alveoli of the mammalian respiratory tract of the respiratory simulator.

51. Use of the respiratory simulator according to any of paragraphs 1 to 26 for determining the effect of a test atmosphere on a simulated distal airway and alveoli of a mammalian respiratory tract.

52. A method of filling the micropores and/or nanopores but not the macropores of a rigid porous foam with an aqueous solution or liquid, the rigid porous foam comprising an interconnected open-celled network of: (i) macropores; and (ii) micropores and/or nanopores, comprising:
(i) supplying an aqueous solution or liquid to the rigid porous foam under negative pressure which in absolute value is larger than a negative pressure arising from a capillarity of the macropores, but smaller than a negative pressure arising from a capillarity of the micropores and/or nanopores; and
(ii) filling the micropores and/or nanopores but not the macropores of the rigid porous foam with the aqueous solution or the liquid.

53. A rigid porous foam for use as a model of a distal airway and alveoli of a respiratory tract comprising an interconnected open-celled network of: (i) macropores, the macropores containing a gas or an aerosol; and (ii) micropores and/or nanopores, the micropores and/or nanopores containing an aqueous solution or liquid, and wherein the micropores and/or nanopores containing the aqueous solution or liquid form an aqueous or liquid layer covering a portion or all of the surface of the macropores.

54. The rigid porous foam according to paragraph 53, wherein the rigid porous foam is: (i) a ceramic or a metallic rigid porous foam; or (ii) a ceramic and a metallic rigid porous foam.

55. The rigid porous foam according to paragraph 53, wherein the rigid porous foam is made of alumina or silicon carbide or oxygen bonded silicon carbide or sintered silicon carbide or a combination of two or more thereof.

56. The rigid porous foam according to any of paragraphs 53 to 55, wherein the rigid porous foam contains walls and struts and wherein the struts of the rigid porous foam contain micropores and/or nanopores and the walls of the macropores of the rigid porous foam are covered with the micropores and/or nanopores that open towards the macropores.

57. The rigid porous foam according to any of paragraphs 53 to 56, comprising one or more cavities or sockets or indentations or a combination of two or more thereof, wherein the one or more cavities or sockets or indentations or a combination of two or more thereof are capable of accepting one or more sensory devices or probes or sampling devices or cell cultures.

58. The rigid porous foam according to paragraph 57, wherein the one or more cavities or sockets or indentations or a combination of two or more thereof contain the one or more sensory devices probes or sampling devices or cell cultures.

59. The rigid porous foam according to any of paragraphs 53 to 58, wherein the rigid porous foam comprises one or more bifurcated channels, suitably, wherein the bifurcated channel(s) bifurcates dichotomously, more suitably, wherein the bifurcated channel(s) is present within the micropores and/or nanopores.

60. The rigid porous foam according to any of paragraphs 53 to 59, wherein the interconnected network of macropores and micropores and/or nanopores comprises:
(i) pairs of macropores connected by a continuous channel formed by the macropores; and
(ii) pairs of micropores and/or nanopores connected by a continuous channel formed by the micropores and/or nanopores; and
(iii) micropores and/or nanopores connected to any macropore by a continuous channel formed by the micropores and/or nanopores and the macropores.

61. The rigid porous foam according to any of paragraphs 53 to 60, wherein the radius of the macropores is between about 0.1 to about 0.4 mm, or between about 0.1 to about 0.3 mm, or between about 0.2 to about 0.4 mm, or between about 0.2 to about 0.3 mm or between about 200 μm and about 2000 μm in diameter, suitably about 820 μm±150 μm in diameter.

62 The rigid porous foam according to any of paragraphs 53 to 61, wherein the radius of the micropores and/or nanopores are between about 0.01 μm and about 50 μm in diameter, suitably, below about 30 μm in diameter or between about 0.25 μm and about 25 μm.

63. The rigid porous foam according to any of paragraphs 53 to 62, wherein the total surface area of the rigid porous foam is at least about 70 square meters, suitably at least about 100 square meters.

64. The rigid porous foam according to any of paragraphs 53 to 63, comprising at least two rigid porous foams each of different pore size distribution or each of different porosity or each of a different material.

65. The rigid porous foam according to any of paragraphs 53 to 64, wherein the aqueous solution or liquid below the surfaces spanning the micropores and/or nanopores has a negative pressure relative to the environment that is larger in absolute value than the negative pressure, in absolute value and relative to the environment, below the aqueous solution or liquid surfaces spanning the macropores.

66. The rigid porous foam according to any of paragraphs 53 to 65, wherein the rigid porous foam has a cylindrical shape or a disc shape or a cuboid shape.

67. The rigid porous foam according to paragraph 66, wherein the cylindrically shaped or disc shaped or cuboid shaped rigid porous foam comprises a radial wall that is made of a different material to the rigid porous foam.

68. The rigid porous foam according to paragraph 67, wherein the different material does not contain macropores or wherein the different material is a synthetic material, preferably, an epoxy resin or a metal or a combination thereof.

69. The rigid porous foam according to any of paragraphs 53 to 68, wherein a bridging structure contacts the rigid porous foam, preferably wherein a bridge is joined to the bridging structure, preferably, wherein the bridge is flexible.

70. The rigid porous foam according to any of paragraphs 53 to 69, wherein the rigid porous foam is contained or mounted inside a pump, suitably, a piston pump.

71. A pump for displacing a volume of gas comprising or housing inside the pump a rigid porous foam, the rigid porous foam comprising an interconnected open-celled network of: (i) macropores; and (ii) micropores and/or nanopores as described herein, optionally wherein the rigid porous foam is connected to a port for receiving and outputting the gas.

72. A system for determining the interaction between a test atmosphere and a simulated respiratory tract, said system comprising:
(a) a first pump comprising:
   (i) a chamber configured for containing a first volume of gas comprising a test atmosphere;
   (ii) a first port adapted for receiving and outputting gas and comprising a valve for regulating the flow of gas through the first port, said valve being moveable between open and closed positions, wherein in the open position said valve is openable towards a test atmosphere or surrounding air;
   (iii) a second port adapted for outputting and receiving gas and comprising a valve for regulating the flow of gas through the second port, said valve being moveable between open and closed positions;
   (iv) a piston plate in the chamber, said piston plate comprising one or more apertures for the uptake or inflow of gas into the chamber wherein one or more, or each, of the apertures include a valve that is movable between open and closed positions and is capable of regulating the uptake or inflow of gas; and
   (v) a motor for controlling the operation of the first pump;
(b) a second pump, wherein the second pump is as defined in paragraph 71;
(c) a connecting structure operable to transmit the gas from the first pump into the second pump; and
(d) one or more openings in the first pump or the second pump or the walls of the connecting structure or a combination of two or more thereof, said openings being capable of receiving a module for containing a matrix comprising a cell culture medium and/or at least one microsensor for monitoring conditions in the chamber or for gas sampling or for gas characterisation.

73. A method for simulating the interaction between a test atmosphere and a simulated respiratory tract comprising the use of the respiratory simulator according to any of paragraphs 1 to 26, or the rigid porous foam according to any of paragraphs 53 to 70 or the pump according to paragraph 71 or the system according to paragraph 72.

74. Use of the respiratory simulator according to any of paragraphs 1 to 26, or the rigid porous foam according to any of paragraphs 53 to 70 or the pump according to paragraph 71 or the system according to paragraph 72 for simulating the interaction between a test atmosphere and a simulated respiratory tract or for determining the effect of a test atmosphere on a culture of cells contained in the rigid porous foam or the pump or the system.

75. A method for determining the effect of a test atmosphere on a culture of cells contained in a simulated respiratory tract comprising the use of the respiratory simulator according to any of paragraphs 1 to 26, or the rigid porous foam according to any of paragraphs 53 to 70 or the pump according to paragraph 71 or the system according to paragraph 72.

76. A method for determining the effect of a test atmosphere on a culture of cells contained in a simulated respiratory tract comprising:
(a) providing the respiratory simulator according to any of paragraphs 1 to 26, or the rigid porous foam according to any of paragraphs 53 to 70 or the pump according to paragraph 71 or the system according to paragraph 72, wherein the rigid porous foam or the pump or system contains a culture of cells and/or at least one sensor in one or more modules; and
(b) comparing the culture of cells and/or the at least one sensor before and/or after exposure to the test atmosphere, wherein a difference between the culture of cells and/or the at least one sensor before and/or after exposure of the cells and/or the at least one sensor to the test atmosphere is indicative that the test atmosphere effects the culture of cells and/or the at least one sensor.

77. An apparatus configured to or adapted to perform the method of any one of paragraphs 50, 73, 75 or 76.

Any publication cited or described herein provides relevant information disclosed prior to the filing date of the present application. Statements herein are not to be construed as an admission that the inventors are not entitled to antedate such disclosures. All publications mentioned in the above specification are herein incorporated by reference. Various modifications and variations of the invention will be apparent to those skilled in the art without departing from the scope and spirit of the invention. Although the invention has been described in connection with specific preferred embodiments, the invention as claimed should not be unduly limited to such specific embodiments. Indeed, various modifications of the described modes for carrying out the invention which are obvious to those skilled in the art and are intended to be within the scope of the following claims.

1.-15. (canceled)

16. A respiratory simulator comprising a rigid porous foam, the rigid porous foam comprising an interconnected open-celled network of: (i) macropores, and (ii) micropores and/or nanopores.

17. The respiratory simulator according to claim 16, wherein the rigid porous foam is: (i) a ceramic or a metallic rigid porous foam, or (ii) a ceramic and a metallic rigid porous foam.

18. The respiratory simulator according to claim 17, wherein the rigid porous foam is made of alumina or silicon carbide or oxygen bonded silicon carbide or sintered silicon carbide or a combination of two or more thereof.

19. The respiratory simulator according to claim 16, wherein: (i) the macropores contain a gas or an aerosol, or (ii) the micropores and/or nanopores contain an aqueous solution or liquid, or (iii) the macropores contain a gas or an aerosol and the micropores and/or nanopores contain an aqueous solution or liquid.

20. The respiratory simulator according to claim 19, wherein the micropores and/or nanopores containing the aqueous solution or liquid form an aqueous or liquid layer covering a portion or all of the surface of the macropores.

21. The respiratory simulator according to claim 16, wherein the rigid porous foam comprises one or more cavities or sockets or indentations or a combination of two or more thereof.

22. The respiratory simulator according to claim 21, wherein the one or more cavities or sockets or indentations or a combination of two or more thereof contain one or more sensory devices or probes or sampling devices or cell cultures.

23. The respiratory simulator according to claim 16, further comprising at least two rigid porous foams each of different pore size distribution or each of different porosity or each of a different material.

24. The respiratory simulator according to claim 16,
further comprising a pump,
wherein the rigid porous foam is contained or mounted inside the pump.

25. A method of simulating distal airways and alveoli of a respiratory simulator, the method comprising:
simulating, using a rigid porous foam, the distal airways and alveoli of the respiratory simulator,
wherein the rigid porous foam comprises an interconnected open-celled network of: (i) macropores and (ii) micropores and/or nanopores.

26. The method according to claim 25, wherein the rigid porous foam is: (i) a ceramic or a metallic rigid porous foam, or (ii) a ceramic and a metallic rigid porous foam.

27. The method according to claim 26, wherein the rigid porous foam is made of alumina or silicon carbide or oxygen bonded silicon carbide or sintered silicon carbide or a combination of two or more thereof.

28. A method for determining an effect of a test atmosphere on a simulated distal airway and alveoli of a respiratory tract, the method comprising:
providing the respiratory simulator according to claim 16;
contacting the respiratory simulator with the test atmosphere; and
determining the effect of the test atmosphere on the simulated distal airway and alveoli of the respiratory tract.

29. A rigid porous foam for a model of a distal airway and alveoli of a respiratory tract comprising an interconnected open-celled network of: (i) macropores, the macropores containing a gas or an aerosol, and (ii) micropores and/or nanopores, the micropores and/or nanopores containing an aqueous solution or liquid, wherein the micropores and/or nanopores containing the aqueous solution or liquid form an aqueous or liquid layer covering a portion or all of the surface of the macropores.

30. The rigid porous foam according to claim 29, wherein the rigid porous foam is: (i) a ceramic or a metallic rigid porous foam, or (ii) a ceramic and a metallic rigid porous foam.

31. The rigid porous foam according to claim 30, wherein the rigid porous foam is made of alumina or silicon carbide or oxygen bonded silicon carbide or sintered silicon carbide or a combination of two or more thereof.

32. The rigid porous foam according to claim 29, wherein: (i) the macropores contain a gas or an aerosol, or (ii) the micropores and/or nanopores contain an aqueous solution or liquid, or (iii) the macropores contain a gas or an aerosol and the micropores and/or nanopores contain an aqueous solution or liquid.

33. The rigid porous foam according to claim 29, further comprising one or more cavities or sockets or indentations or a combination of two or more thereof.

34. The rigid porous foam according to claim 29, wherein the one or more cavities or sockets or indentations or a combination of two or more thereof contain one or more modules configured to contain or to store a cell culture medium and/or at least one microsensor configured to monitor conditions in a chamber or for gas sampling or for gas characterization.

35. The rigid porous foam according to claim 29, wherein the rigid porous foam is contained or mounted inside a pump.
